(19) United States
(12) Patent Application Publication
(10) Pub. No.: US 2026/0336097 A1
(43) Pub. Date: Oct. 29, 2026

(54) JAMMABLE APPARATUSES

(71) Applicant: Auckland UniServices Limited, Auckland (NZ)

(72) Inventors: Geng GAO, Auckland (NZ); Junbang LIANG, Auckland (NZ); Minas LIAROKAPIS, Auckland (NZ)

(21) Appl. No.: 19/113,619

(22) PCT Filed: Oct. 13, 2023
(86) PCT No.: PCT/IB2023/060327

§ 371 Date: Mar. 20, 2025

(30) Foreign Application Priority Data
Oct. 14, 2022 (NZ) 793415

(51) Int. Cl. B25J 9/14; B25J 9/00; B25J 9/10; B25J 18/06

(52) U.S. Cl. CPC B25J 9/142; B25J 9/0006; B25J 9/106; B25J 9/1075; B25J 18/06

(57) ABSTRACT

Disclosed in one aspect is an apparatus comprising: a conformable envelope configured to exert a constricting force corresponding to a difference between an internal pressure and a greater external pressure of the envelope; an assembly comprising a plurality of rotatably associated rotation members arranged in the envelope and configured to rotatably move away from a first assembly position and toward a second assembly position in response to the constricting force; and a first intermediate component arranged between the envelope and the assembly and configured to facilitate movement of the assembly between the first assembly position and the second assembly position.

### FIELD OF TECHNOLOGY

The present disclosure relates to variable stiffness structures, more particularly but not limited to jammable apparatuses, articulable apparatuses, actuating jammable apparatuses, and applications of the same such as in robotics.

### BACKGROUND

Task robotization and automation increasingly involve the execution of complex tasks in unstructured and dynamic environments. In such situations, rigid robots require complex control algorithms, and sophisticated proprioception systems are needed to position a rigid robot with sufficient accuracy to complete associated task. Sophisticated sensing systems may also be required to enable rigid robots to operate safely around humans and to interact with delicate or fragile objects.

Soft robotic mechanisms and compliant structures in rigid robots have been developed by the integration of flexible materials. The structural compliance provided by the integration of flexible materials may increase a robot's environmental adaptability, while also reducing the associated control and sensing requirements. The structural compliance may also provide increased safety in interactions with humans and the ability to non-destructively interact with delicate or fragile objects, particularly in the absence of sophisticated sensing systems for measuring the applied pressures.

However, the use of flexible materials may decrease the control reliability of a robot. It may also reduce the force exertion capabilities of the robot and reduce its resistance to deformation.

Variable stiffness actuators attempt to provide the benefits of soft robots while limiting or reducing their aforementioned disadvantages by providing on-demand rigidity to soft elements within a robotic system. Various forms of variable stiffness actuators have been developed.

Shape memory alloys and shape memory polymers facilitate stiffness variation through changes in the material temperature. They may provide reasonable increases in stiffness, but the time required to change the temperature of the material to effect the change in stiffness leads to slow response times that may be impractical.

Voltage actuated dielectric elastomer actuators, using methods such as electrostatic chunking, active cross-section changing, or the integration of low melting point alloys, may also be used to vary the stiffness of a system. Applications of such dielectric elastomers are extremely limited due to their low force exertion capabilities.

Magnetorheological fluids having magnetizable particles within a carrier fluid can, in the presence of a magnetic field, exhibit changes in viscosity and shear modulus. This can provide variations in stiffness of a soft structure including the magnetorheological fluids. However, applications of such systems may be limited by the adverse effects of the required magnetic fields on other magnetically sensitive componentry.

US Patent Publication No. 20200130175A1 relates to an artificial muscle system. The artificial muscle system has a collapsible skeleton contained inside a volume defined by a flexible skin, and a muscle actuation mechanism to increase or decrease the pressure inside the envelope. The collapsible skeleton may take different forms including rigid segments linked with flexures that allow the rigid segments to pivot relative to one another. When a pressure difference exists between the inside of the sealed volume and a surrounding environment, the flexible skin provides a pulling force on the collapsible skeleton and the collapsible skeleton may be deployed, contracted, or bent. A change in dimension of the collapsible skeleton when actuated corresponds to the actuation that the artificial muscle system provides. These configurations, however, suffer from durability, motion, performance, and other issues.

### SUMMARY

It is an object of the present disclosure to provide an improved variable stiffness structure which addresses or ameliorates one or more disadvantages or limitations associated with the prior art, or which at least provides the public with a useful choice.

Additionally or alternately, it may be an object of the present disclosure to provide an improved jammable apparatus which is operable between a first apparatus shape and a second apparatus shape and exhibits a change in stiffness between the first and second apparatus shapes.

Additionally or alternately, it may be an object of the present disclosure to provide an improved jammable apparatus that has a first apparatus shape towards which it is passively biased and a second apparatus shape towards which it is actuatable under vacuum pressure, and where under vacuum a stiffness of the apparatus is increased.

Additionally or alternately, it may be an object of the present disclosure to provide a variable stiffness joint for a robotic system.

Additionally or alternately, it may be an object of the present disclosure to provide an exoskeleton or assistive robotic device including at least one jammable apparatus.

Additionally or alternately, it may be an object of the present disclosure to provide a variable stiffness robotic actuator that includes at least one jammable apparatus.

The following statements summarise different aspects of the disclosure.

1. In a first aspect, the disclosure provides for an apparatus comprising:
a conformable envelope configured to exert a constricting force on an inside of the envelope in response to a pressure on an outside of the envelope being greater than a pressure on the inside of the envelope,
an assembly comprising rotatably associated members, the assembly provided inside the envelope and articulable between a first assembly shape and a second assembly shape, and
a first intermediate component located between the assembly and the envelope and configured to facilitate articulation of the assembly,
the assembly being configured to articulate to, or be maintained in, the second assembly shape in the presence of the constricting force.

2. The apparatus of statement 1, wherein when the assembly is in the second assembly shape and in the presence of the constricting force, the apparatus assumes a jammed condition.

3. The apparatus of statement 2, wherein once in the jammed condition, the apparatus remains in the jammed condition until a cessation of the constricting force.

4. The apparatus of statement 2 or 3, wherein the first assembly shape and second assembly shape correspond respectively to a first apparatus shape and a second apparatus shape, and in the jammed condition a stiffness of the apparatus in moving between the second apparatus shape and the first apparatus shape is increased relative to a non-jammed condition of the apparatus.

5. The apparatus of statement 4, wherein in the jammed condition the apparatus is resiliently articulable away from the second apparatus shape. This may occur, for example, in the presence of a sufficient force being applied to the assembly in the jammed condition.

6. The apparatus of statement 4 or 5, wherein if the apparatus in the jammed condition is articulated away from the second apparatus shape by a deforming force, upon a removal of the deforming force the apparatus returns to or towards the second apparatus shape.

7. The apparatus of any one of statements 4-6, wherein the assembly further comprises a bendable base layer, and the members are arrayed along a first surface of the base layer and each partially attached thereto, such that upon a bending movement of the base layer in a first direction at least some of the members are rotated relative to one another.

8. The apparatus of statement 7, wherein each member has at least one unattached peripheral portion, such that upon bending of the base layer in the first direction the or each unattached peripheral portion of at least some of the members are displaced away from the base layer, the unattached peripheral portions each defining a lever arm.

9. The apparatus of statement 8, wherein when at least some of the lever arms are displaced away from the base layer when the assembly is articulated to the first assembly shape and are undisplaced from the base layer when the assembly is articulated to the second assembly shape.

10. The apparatus of statement 8 or 9, wherein the constricting force acts against the lever arms to compress the assembly from the first assembly shape to or towards the second assembly shape.

11. The apparatus of any one of statements 8-10, wherein the assembly is in an expanded state in the first assembly shape and a collapsed state in the second assembly shape.

12. The apparatus of statement 11, wherein the first intermediate component is slidable between the assembly and the envelope during an articulation of the assembly.

13. The apparatus of statement 12, wherein the first intermediate component is located at a side of the assembly opposite to the base layer.

14. The apparatus of statement 13, wherein in the first assembly shape a mean displacement between the base layer and the first intermediate component is decreased relative to in the second assembly shape.

15. The apparatus of any one of statements 8-14, wherein the first intermediate component resists local deformation by action of the lever arms against the first intermediate component.

16. The apparatus of any one of statements 8-15, wherein the assembly is bendable in the first direction, and resists bending in an opposite second direction.

17. The apparatus of statement 7, wherein the rotatably associated members of the assembly are pivotably associated with one another, and the assembly has an opposed first and second sides.

18. The apparatus of statement 17, wherein at least one member includes an extension beyond a pivot with an associated member to define a lever arm.

19. The apparatus of statement 18, wherein when the assembly is in the first assembly shape, at least one lever arm projects outwardly of the assembly.

20. The apparatus of statement 18, wherein when the assembly is in the first assembly shape, a plurality of lever arms project outwardly from each of the first side and a second side of the assembly.

21. The apparatus of any one of statements 18-20, wherein the constricting force acts against each at least one projecting lever arm to actuate the assembly from the first assembly shape to or towards the second assembly shape.

22. The apparatus of any one of statements 18-21, wherein when the assembly is in the second assembly shape, each at least one lever arm is retracted within the assembly.

23. The apparatus of any one of statements 18-22, wherein when the assembly is in the second assembly shape, each at least one lever arm longitudinally overlaps with at least one adjacent member to which said at least one lever arm is pivotably associated.

24. The apparatus of any one of statements 17-23, wherein the assembly is in an expanded state in the first assembly shape and a collapsed state in the second assembly shape.

25. The apparatus of statement 24, wherein the first intermediate component is provided adjacent the first side of the assembly, and the apparatus further comprises a second intermediate component located between the assembly and the envelope and provided adjacent the second side of the assembly.

26. The apparatus of statement 25, wherein a separation between the first intermediate component and second intermediate component is greater when the assembly is in the expanded state than when the assembly is in the collapsed state.

27. The apparatus of statement 25, wherein a volume between the first intermediate component and second intermediate component is greater when the assembly is in the expanded state than when the assembly is in the collapsed state.

28. The apparatus of any one of statements 25-27, wherein the first intermediate component and second intermediate component each act to resist local deformation by action of the lever arms against them.

29. The apparatus of any one of statements 24-28, wherein the members of the assembly are pivotably associated with each other and arranged in a two-dimensional array, and in the expanded state at least one lever arm projects outwardly of one of the first and second sides of the two-dimensional array.

30. The apparatus of statement 29, wherein in the expanded state a plurality of lever arms project outwardly from both of the first and second opposed sides of the two-dimensional array of the assembly.

31. The apparatus of statement 29 or 30, wherein the two-dimensional array comprises a plurality of laterally adjacent members and a plurality of longitudinally adjacent members.

32. The apparatus of statement 29 or 30, wherein the two-dimensional array comprises, with respect to a pivot axis of the members, a plurality of members arranged along the pivot axis and a plurality of members arranged laterally of the pivot axis.

33. The apparatus of any one of statements 29-32, wherein the assembly has a plurality of pivot axes of the members about each other, and at each pivot axis the array comprises at least three members arranged along the pivot axis.

34. The apparatus of statement 33, wherein the assembly has one or more lengths measured between successive pivot axes, one or more widths measured along its pivot axes, and a height, and wherein only the height of the assembly changes when the assembly articulates between the first assembly shape and the second assembly shape.

35. The apparatus of statement 34, wherein the height of the assembly is a maximum dimension of the assembly taken perpendicularly to both of the length and width of the assembly.

36. The apparatus of any one of statements 4-35, wherein the assembly is configured to articulate to and maintain the assembly in the second assembly shape in the presence of the constricting force.

37. The apparatus of any one of statements 17-36, wherein the apparatus has a biased shape to or towards which the apparatus is biased to return in an absence of the constricting force.

38. The apparatus of any one of statements 17-37, wherein the or each intermediate component has a biased shape, and, when deformed away from its biased shape, the or each intermediate component exerts a returning force to return the apparatus to or towards the biased shape of the or each intermediate component.

39. The apparatus of statement 38, wherein the biased shape of the or each intermediate component is configured to correspond to the first assembly shape, such that on the exertion of the constricting force the apparatus is actuated from the first apparatus shape to the second apparatus shape, and upon a cessation of the constricting force the apparatus is returned from the second apparatus shape to or towards the first apparatus shape.

40. The apparatus of statement 38 or 39, wherein the biased shape of the or each intermediate component is configured to correspond to the second assembly shape, such that on the exertion of the constricting force the apparatus is retained in the second apparatus shape.

41. The apparatus of statement 40, wherein the maintaining of the assembly in the second assembly shape in the presence of the constricting force comprises an increased stiffness of the assembly to articulate away from the second assembly shape.

42. The apparatus of statement 40 or 41, wherein if the apparatus is initially deflected away from the second apparatus shape, the exertion of the constricting force actuates the apparatus to return to or towards the second apparatus shape.

43. The apparatus of any one of statements 17-42 the members are links, such that the assembly defines a pivotably articulable linkage.

44. The apparatus of any one of statements 1-43, wherein the or each intermediate component is/are slidable with the assembly and the envelope during articulation of the assembly.

45. The apparatus of any one of statements 1-44, wherein the or each intermediate component is/are bendable but resistant to in-plane deformation.

46. The apparatus of statement 45, wherein the or each intermediate component is/are elastically bendable.

47. The apparatus of statement 45 or 46, wherein the or each intermediate component is/are elastically inextensible in-plane.

48. The apparatus of any one of statements 1-47, wherein the or each intermediate component has a relatively greater surface hardness than a surface hardness of the envelope.

49. The apparatus of any one of statements 1-48, wherein the envelope is elastically deformable in-plane.

50. The apparatus of any one of statements 1-16, wherein one or more of the members of the assembly has a substantially linear shape.

51. The apparatus of any one of statements 1-16, wherein one or more of the members of the assembly have a curved shape.

52. The apparatus of any one of statements 17-49, wherein one or more of the members of the assembly is substantially linear between respective pivots of the member.

53. The apparatus of any one of statements 17-49 or 52, wherein one or more of the members of the assembly are curved between respective pivots of the member.

54. The apparatus of any one of statements 17-49, 52, or 53, wherein the shape of each of the members of the array are configured to define a desired second apparatus shape.

55. In another aspect, the disclosure provides an apparatus comprising:
a conformable envelope configured to exert a constricting force on an inside of the envelope in response to a pressure on an outside of the envelope being greater than a pressure on the inside of the envelope, and
an assembly comprising relatively rotatable members provided inside the envelope, the assembly being reconfigurable by relative rotations of the members between a first assembly shape and a second assembly shape, the members of the assembly being relatively more contiguous with each other in the second assembly shape than in the first assembly shape,
the assembly being reconfigurable from the first assembly shape to the second assembly shape by the constricting force exerted by the conformable envelope.

56. The apparatus of statement 55, wherein the apparatus becomes jammed once the assembly is in the second assembly and subject to the exertion of the constricting force.

57. The apparatus of statement 55 or 56, wherein where the assembly has the first assembly shape the apparatus has a corresponding first assembly shape, and where the assembly has the second assembly shape the apparatus has a corresponding second assembly shape.

58. The apparatus of any one of statements 55-57, wherein the reconfiguration of the assembly between the first assembly shape and second assembly shape provides an actuation of the apparatus between the first apparatus shape and second apparatus shape.

59. The apparatus of any one of statements 55-58, wherein the reconfiguration of the relatively rotatable members of the assembly between the first assembly shape and second assembly shape comprises a compression of the assembly in one dimension by the rotation of the members relative to each other

60. The apparatus of statement 59, wherein the reconfiguration of the assembly between the first assembly shape and the second assembly shape comprises a compression of the assembly in only the one dimension.

61. The apparatus of any one of statements 55-60, wherein at least some of the members include at least one distal extension past a point of rotation of the member to define a lever arm, and away from the first assembly shape the or each lever arm projects outwardly of the assembly such that the or each lever arm is non-contiguous with adjacent members of the assembly.

62. The apparatus of statement 61, wherein in the second assembly shape the or each lever arm is rotatably retracted to lie within the assembly such that the or each lever arm is contiguous with adjacent members of the assembly.

63. The apparatus of statement 60 or 61, wherein in the second assembly shape each at least one lever arm longitudinally overlaps with at least one adjacent member to which it is relatively rotatable.

64. The apparatus of any one of statements 61-63, wherein in reconfiguring between the first assembly shape and the second assembly shape, the constricting force exerted by the conformable envelope acts on each at least one lever arm to urge them towards a relatively more contiguous relationship with adjacent members of the assembly.

65. The apparatus of any one of statements 61-64, wherein the apparatus further comprises an intermediate component located between a side of the assembly and the envelope and slidable there between during reconfiguration of the assembly between the first assembly shape and second assembly shape.

66. The apparatus of any one of statements 61-64, wherein the apparatus further comprises two intermediate components, a first intermediate component located between a first side of the assembly and the envelope, and a second intermediate component located between an opposing second side of the assembly and the envelope, and each intermediate component slidable therewith to facilitate the reconfiguration of the assembly between the first assembly shape and second assembly shape.

67. The apparatus of statement 65 or 66, wherein upon the exertion of the constricting force, the or each intermediate component acts against the or each lever arm to reconfigure the assembly from the first assembly shape to the second assembly shape.

68. The apparatus of any one of statements 65-67, wherein the or each intermediate components are each laminar, and under the exertion of the constricting force and once the assembly is in the second assembly shape, the assembly, the or each intermediate components, and the conformable envelope all laminarly jam against each other.

69. The apparatus of any one of statements 65-68, wherein the or each intermediate components have a biased shape and are resiliently deformable therefrom yet when deformed away from their biased shape exert a returning force on the apparatus towards the biased shape of the or each intermediate components.

70. The apparatus of statement 69, wherein the biased shape of the or each intermediate component corresponds to the first assembly shape of the assembly, and upon a cessation of the constricting force the apparatus returns to or towards the second assembly shape of the assembly.

71. The apparatus of statement 69, wherein the biased shape of the or each intermediate component corresponds to the first assembly shape of the assembly, and upon a cessation of the constricting force the apparatus remains biased to or towards the second assembly shape of the assembly.

72. The apparatus of any one of statements 55-71, wherein the members each comprise links and the relatively rotatable links are pivotably associated with one another such that the assembly comprises a linkage, and the reconfiguration of the linkage between the first linkage shape and the second linkage shape comprises an articulation of the pivotably associated links of the linkage.

73. The apparatus of statement 72, wherein in the second linkage shape where the members are relatively more contiguous with each other than in the first linkage shape, a first side of the linkage defines a substantially continuous surface.

74. The apparatus of statement 73, wherein in the first linkage shape where the members are relatively less contiguous with each other than in the second linkage shape, the first side of the linkage defines a substantially discontinuous surface.

75. The apparatus of statement 73 or 74, wherein the linkage of pivotable associated links comprises an array of links arranged in both longitudinal and lateral directions.

76. The apparatus of statement 75, wherein in the first linkage shape the linkage comprises one or more internal voids through a height of the linkage.

77. The apparatus of statement 76, wherein in the first linkage shape each of the one or more internal voids through the height of the linkage corresponds to a lever arm of the linkage.

78. The apparatus of statement 76 or 77, wherein in the second linkage shape a corresponding one or more of the at least one lever arms are located within each of the one or more internal voids present in the first linkage shape.

79. The apparatus of any one of statements 72-77, wherein the linkage has a plurality of lever arms, each lever arm comprises a distal extension of the associated link past the pivotable association of the link with another link, and the linkage is reconfigurable from the first linkage shape to its second linkage shape by action of the constricting force against the plurality of lever arms and a consequent pivoting of the links of the linkage relative to each other.

80. The apparatus of statement 78, wherein the links of the linkage are substantially rigid.

81. The apparatus of any one of statements 72-79, wherein the linkage has a plurality of pivot axes of the links about each other, and the linkage has a) a length measured between successive pivot axes, a) width measured along a given pivot axis, and c) a height, and wherein only the height of the linkage changes between the first linkage shape and the second linkage shape.

82. The apparatus of statement 80, wherein the height is measured as a maximum distance between respective furthest extents of the linkage in directions perpendicular to both the length and the width of the linkage.

83. The apparatus of statement 81, wherein the height of the linkage is greater in the first linkage shape than in the second linkage shape.

84. In another aspect, the disclosure provides an apparatus comprising:
a flexible envelope,
a plurality of relatively rotatable members, and
an intermediate component,
wherein the intermediate component is provided at one side of the plurality of relatively rotatable members, the plurality of relatively rotatable members and the intermediate component are both disposed within the envelope, and the apparatus assumes a jammed condition subsequent to the application of a relative vacuum within the envelope.

85. In another aspect, the disclosure provides an apparatus comprising:
a conformable envelope configured to exert a constricting force in response to a relatively greater pressure at an outside than at an inside of the envelope,
an assembly comprising members disposed in the envelope, the members arranged pivotably with respect to one another, and the assembly configured to assume a jammed shape in response to the constricting force, and
a first intermediate component located between a side of the assembly and the envelope and slidable therebetween during pivoting of the members of the assembly.

86. In another aspect, the disclosure provides an apparatus comprising:
a contractable envelope,
an assembly comprising rotatably associated members provided within the envelope, and
an intermediate component located between a side of the assembly and the envelope,
wherein upon the exertion of a constricting force by the envelope the assembly articulates to change shape and the apparatus transitions to a jammed state.

87. In another aspect, the disclosure provides an actuator comprising:
a conformable envelope having an inside and an outside,
an assembly comprising an array of pivotably associated members disposed inside the envelope, where an end of one or more members extends beyond a pivot point of the member to define a lever arm,
wherein the assembly is operable to articulate, in response to a constricting force exerted on a content of the envelope, from an expanded condition where the lever arm or arms project outwardly from the array to a compressed condition where the lever arm or arms lie substantially within the array, and
wherein between the expanded condition and the compressed condition the assembly and consequently the actuator changes shape from a first shape to a second shape.

88. The actuator of statement 87, wherein the array of pivotably associated members comprises a two-dimensional array of pivotably connected members.

89. The actuator of statement 87 or 88, wherein the actuator further comprises an intermediate component located between a first side of the two-dimensional array of the assembly and the envelope, and the intermediate component is slidable therewith during the reconfiguration of the assembly between its expanded condition and its compressed condition.

90. The actuator of statement 89, wherein the intermediate component has a biased shape and when deformed away from their biased shape exert a returning force on the apparatus towards the biased shape of the intermediate component.

91. The actuator of any one of statements 88-90, wherein when the assembly is in its expanded condition an array-perpendicular dimension of the assembly is greater than a corresponding array-perpendicular dimension of the assembly when the assembly is in its compressed condition.

92. The actuator of any one of statements 88-91, wherein at least one of the members of the two-dimensional array of members comprises a distal extension past a pivot point of the member, and when the assembly is articulated away from its compressed shape an application of the constricting force urges the or each distal extension inwards towards the array.

93. In another aspect, the disclosure provides an apparatus comprising a conformable envelope and disposed in an inside of the envelope an assembly comprising a two-dimensional array of pivotably associated members such that the assembly can reconfigure between a first shape and a second shape, wherein upon the exertion of a constricting force by the envelope a jamming of the apparatus is preceded by a forcing by the constricting force of the assembly towards the second assembly shape.

94. The apparatus of statement 93, wherein the apparatus further comprises an intermediate component located between a first side of the two-dimensional array of the assembly and the envelope, and slidable therewith during the reconfiguration of the assembly between the first assembly shape and the second assembly shape.

95. The actuator of statement 94, wherein the intermediate component has a biased shape and when deformed away from their biased shape exert a returning force on the apparatus towards the biased shape of the intermediate component.

96. The actuator of any one of statements 93-95, wherein when the assembly is in the first assembly shape an array-perpendicular dimension of the assembly is greater than a corresponding array-perpendicular dimension of the assembly when the assembly is in the second assembly shape.

97. The actuator of any one of statements 93-96, wherein at least one of the members of the array of pivotably associated members comprises a distal extension past a pivot point of the member, and when the array is in the first assembly shape an application of the constricting force urges the or each distal extension towards the array.

98. In another aspect, the disclosure provides a structure comprising:
an array of relatively pivotable members, the array articulable between an expanded state in which the array has a first shape and a compressed state in which the array has a second shape, and
a conformable envelope within which the array is provided,
wherein a mean separation between two notional surfaces bounding an opposed first and second sides of the array decreases as the assembly articulates between its expanded state and compressed state.

99. In another aspect, the disclosure provides a linkage assembly for an apparatus, the linkage assembly comprising:
an array of relatively pivotable links, the array articulable between a first shape and a second shape,
wherein between the first shape and the second shape an array-perpendicular dimension of the linkage assembly changes.

100. The linkage assembly of statement 99, wherein the array-perpendicular dimension of the linkage assembly is greater in the first shape than in the second shape, and the array is compressible in the array-perpendicular direction to articulate the linkage assembly between the first assembly shape and second shape.

101. In another aspect, the disclosure provides an apparatus comprising:
a conformable envelope configured to exert a constricting force corresponding to a difference between an internal pressure and a greater external pressure of the envelope;
an assembly comprising a plurality of rotatably associated rotation members arranged in the envelope and configured to rotatably move away from a first assembly position and toward a second assembly position in response to the constricting force; and
a first intermediate component arranged between the envelope and the assembly and configured to facilitate movement of the assembly between the first assembly position and the second assembly position.

102. The apparatus of statement 101, wherein the first intermediate component is configured to resiliently exert a returning force to cause the assembly to move away from the second assembly position and toward the first assembly position in response to the constricting force being smaller than the returning force.

103. The apparatus of statement 102, wherein the returning force is exerted on one of the envelope and the assembly.

104. The apparatus of any one of statements 101 to 103, wherein the first intermediate component is configured to resist local deformation.

105. The apparatus of any one of statements 101 to 104, wherein the first intermediate component is configured to be slidably moveable relative to the envelope.

106. The apparatus of any one of the statements 101 to 105, wherein the first intermediate component has a sliding surface configured to facilitate slidable movement of the assembly thereon.

107. The apparatus of any one of statements 101 to 106, further comprising:
a second intermediate component arranged between the envelope and the assembly, the assembly being arranged between the first and second intermediate components.

108. The apparatus of any one of statements 101 to 107, wherein the assembly further comprises:
a plurality of elongated pivot members to which the rotation members are rotatably coupled.

109. The apparatus of statement 108, wherein each intermediate one of the rotation members are rotatably coupled to a respective neighbouring pair of the pivot members.

110. The apparatus of statement 109, wherein each intermediate one of the rotation members is arranged symmetrically with respect to the respective pair of the pivot members.

111. The apparatus of any one of statements 108 to 110, wherein the rotation members coupled to an intermediate one and a previous one of the pivot members are interleaved with those coupled to the intermediate one and a next one of the pivot members.

112. The apparatus of any one of statements 108 to 111, wherein each of the rotation members is rotatably coupled at a proximal end thereof to one of the pivot members.

113. The apparatus of statement 112, wherein, for each of the pivot members, each adjacent pair of the corresponding rotation members forms a respective angle in the second assembly position.

114. The apparatus of statement 112 or 113, wherein the rotation members of each of the pivot members are arranged symmetrically with respect to the rotation members of an adjacent one of the pivot members.

115. The apparatus of any one of statements 108 to 114, wherein each rotation member is rotatably coupled to at least one of the pivot members, and is formed with a plurality of coupling holes greater in number than the corresponding at least one of the pivot members.

This may be advantageous in that each rotation member has coupling holes that are greater in number than the corresponding at least one of the pivot members to facilitate different, selective coupling hole engagement depending on applications. This may be useful for achieving different, corresponding rotational configurations of the respective rotation member with respect to the corresponding at least one of the pivot members. In other words, for each rotation member, a number of the coupling holes of the rotation member is greater than a number of the at least one of the pivot members corresponding to the rotation member.

116. The apparatus of any one of statements 101 to 107, wherein the assembly further comprises:
a flexible base layer which is arranged in the envelope and on which the rotation members are arranged.

117. The apparatus of statement 116, wherein the base layer is configured to resiliently exert a restoring force to facilitate movement of the assembly away from the second assembly position and toward the first assembly position in the absence of the constricting force greater than the restoring force.

118. The apparatus of statement 116 or 117, wherein each of the rotation members includes an attachment part fixed to the base layer and a first non-attachment part rotatably moveable about the respective attachment part with respect to the base layer.

119. The apparatus of statement 118, wherein, for each rotation member in a first group, the respective attachment part is arranged toward a first peripheral side of the base layer relative to the respective first non-attachment part.

120. The apparatus of statement 119, wherein, for each rotation member in a second group, the respective attachment part is arranged toward an opposite second peripheral side of the base layer relative to the respective first non-attachment part.

121. The apparatus of statement 118, wherein each rotation member further has a second non-attachment part rotatably moveable about the respective attachment part with respect to the base layer and arranged opposite the respective first non-attachment part with respect to the respective attachment part.

122. The apparatus of any one of statements 101 to 121, wherein the rotation members are jammed in the second assembly position.

123. The apparatus of any one of statements 101 to 122, wherein the rotation members are arcuate or straight in shape.

The rotation members may be configured with any other shapes, depending on applications.

124. The apparatus of any one of statements 101 to 123, wherein the envelope is adapted to receive therein an inner fluid corresponding to the internal pressure, and is adapted to be arranged in an outer fluid corresponding to the external pressure and different from the inner fluid.

125. The apparatus of any one of statements 101 to 124, wherein the envelope is formed with an opening for fluid communication.

The term “axis” as used in this specification means the axis of revolution about which a line or a plane may be revolved to form a symmetrical shape. For example, a line revolved around an axis of revolution will form a surface, while a plane revolved around an axis of revolution will form a solid.

The term “position” as used herein may mean a configuration or a particular way in which something is placed or arranged.

As used herein the term “and/or” means “and” or “or”, or both.

The term “comprising” as used in the specification, including the claims, means “consisting at least in part of.” When interpreting each statement in this specification that includes the term “comprising,” features other than that or those prefaced by the term may also be present. Related terms “comprise” and “comprises” are to be interpreted in the same manner.

The phrase “each other” as used herein may, depending on contexts, be understood to mean “one another”.

This invention or disclosure may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

To those skilled in the art to which the present disclosure relates, many changes in construction and widely differing embodiments and applications of the present disclosure will suggest themselves without departing from the scope of the present disclosure as defined in the appended claims. The disclosures and the descriptions herein are purely illustrative and are not intended to be in any sense limiting.

Other aspects of the present disclosure may become apparent from the following description which is given by way of example only and with reference to the accompanying drawings.

### BRIEF DESCRIPTION OF THE DRAWINGS

The above-described aspects will be explained further by way of example only and with reference to the drawings, in which:

FIGS. 1A and 1B are perspective views of a jammable apparatus in two different apparatus shapes;

FIGS. 2A-C are perspective views of an assembly for a jammable apparatus in three different assembly shapes;

FIG. 2D is a side view of the assembly of FIGS. 2A-C in another assembly shape;

FIGS. 3A-F are topographical schematics of different arrangements of an assembly including relatively rotatable members for a jammable apparatus;

FIG. 4 is a view of an assembly including relatively rotatable members for a jammable apparatus;

FIG. 5 is a perspective view of an assembly including relatively rotatable members for a jammable apparatus;

FIG. 6 is a side view of an assembly including relatively rotatable members for a jammable apparatus;

FIG. 7A is a perspective view of an assembly including relatively rotatable members for a jammable apparatus;

FIGS. 7B-D are side views of the assembly of FIG. 7A in three different assembly shapes;

FIG. 8A is a perspective view of an assembly including relatively rotatable members for a jammable apparatus;

FIG. 8B is a side view of the assembly of FIG. 8A in a first assembly shape;

FIG. 8C is a perspective view of the assembly of FIG. 8A in a second assembly shape;

FIG. 9 is a perspective view of components of a jammable apparatus in a disassembled state, including an envelope, an intermediate layer placed next to the envelope, and an assembly which includes relatively rotatable members and on which the intermediate layer is placed;

FIG. 10A is a side view of an assembly including relatively rotatable members sandwiched between first and second intermediate layers, in a first assembly shape;

FIG. 10B is another side view of the assembly and intermediate layer of FIG. 10A, in a second assembly shape;

FIG. 11A is a perspective view of an assembly including relatively rotatable members with a first intermediate layer arranged on one side thereof, in a first assembly shape;

FIG. 11B is another perspective view of the assembly and the intermediate layer of FIG. 11A, in a second assembly shape;

FIG. 12A is a side view of an assembly including relatively rotatable members sandwiched between first and second intermediate layers, in a first assembly shape;

FIG. 12B is a side view of the components of FIG. 12A assembled with an envelope to provide a jammable apparatus in a first apparatus shape;

FIG. 12C is a side view of the jammable apparatus of FIG. 12B, in a second apparatus shape;

FIG. 13 is a graph of experimental characteristics of a jammable apparatus at different vacuum pressures within an envelope of the jammable apparatus;

FIG. 14 is a graph of experimental characteristics of a jammable apparatus at different vacuum pressures within an envelope of the jammable apparatus;

FIG. 15 is a graph of experimental characteristics of different member thickness configurations of a jammable apparatus;

FIG. 16 is a graph of experimental characteristics of different member thickness configurations of a jammable apparatus;

FIG. 17 is a graph of experimental characteristics of different member-length configurations of a jammable apparatus;

FIG. 18 is a graph of experimental characteristics of different member-length configurations of a jammable apparatus;

FIG. 19 is a graph of experimental characteristics of different configurations of a jammable apparatus;

FIG. 20 is a perspective view of a conventional tendon-driven finger;

FIG. 21 is side view of a tendon-driven finger of two degrees of freedom, with one degree of freedom provided by a jammable apparatus;

FIG. 22 is side view of a tendon-driven finger of two degrees of freedom, with one degree of freedom provided by a jammable apparatus;

FIGS. 23A and 23B are side views of a jammable apparatus where two different magnitudes of a constricting force are exerted by the envelope of the apparatus through the application of two respective different vacuum pressure levels within the envelope;

FIGS. 24A and 24B are side views of an exoskeleton that includes a jammable apparatus, where the jammable apparatus is in a first exoskeleton shape and second exoskeleton shape respectively;

FIGS. 25A and 25B are views of a robotic hand that includes multiple jammable apparatuses, where the robotic hand is actuated to a first robotic hand shape and a second robotic hand shape respectively;

FIG. 26 is an exploded view of components of a jammable apparatus;

FIG. 27A is a partially exploded view of an assembly having members which are pinned together; and

FIG. 27B is a partially exploded view of an assembly having members connected to a base.

### DETAILED DESCRIPTION

Various configurations of an apparatus are provided, as well as combinations of such apparatuses and applications of them. The apparatus may be characterised as a jammable apparatus.

Jamming is a structural phenomenon that provides tuneable mechanical behaviour. Jamming occurs where structures of a closed system are exposed to a relatively greater pressure outside of the system than within it. Under this pressure difference, the components of the closed system experience increased kinematic and frictional interactions, jamming the components against each other.

When in a jammed state, the structures of the closed system have an increased resistance to movement relative to each other compared to the same in an unjammed state. In a jammed state, a jammable system exhibits increased stiffness relative in an unjammed state.

In some arrangements of a jammable system, in an unjammed state the system may exhibit no or substantially no yield point. In the system's jammed state, the system may instead exhibit a yield point.

The jammed state may encompass a range of degrees of jamming of a jammable apparatus, from a condition in which it exhibits just greater than no or substantially no yield point and has a first yield strength and/or first stiffness, up to a condition in which it exhibits a greater or maximum second yield strength and/or greater or maximum second stiffness.

The increased stiffness of a jammable system when jammed provides an increase in the damping that can be provided by the system.

The stiffness of a jammable structure may be changed by altering a pressure difference to which the envelope containing the structure is exposed. The ability of a jammable system to assume a jammed state in which it exhibits increased stiffness, and the ability to further control the stiffness of the system when jammed by control over the pressure difference the system experiences, may provide for a range of desirable functions. That is, in the jammed state, the jammable system is further controllable to adjust a stiffness of the system by way of a corresponding pressure difference adjustment.

Reference herein to a jammable structure or jammable apparatus may be understood to refer to, respectively, a structure or apparatus that is capable of being jammed.

A jammable apparatus according to the disclosure may define a closed system within an envelope. Components of the jammable apparatus are to be provided within an inside of the envelope. The envelope can provide a closed system to permit a pressure difference to be applied between an outside of the envelope and an inside of the envelope. The difference involves a relatively greater pressure outside the envelope than within it. The pressure difference may be provided by a decrease in pressure within the envelope, an increase in pressure outside of the system, or some combination of the two. When the pressure within the envelope is less than the pressure outside of it, the envelope contracts and exerts a constricting force on any contents within the envelope.

A pressure difference such that the inside of the envelope is at a lower than the outside of the envelope may be provided by the fluid connection of a vacuum pressure source to the inside of the envelope. Reference to a vacuum pressure will be understood to be a vacuum pressure relative to a pressure outside of the envelope. While reference may be made to the application of a vacuum pressure, it will be appreciated that application of a positive pressure to the outside of an envelope may additionally or alternatively be employed to provide the requisite pressure difference across the envelope to generate a constricting force within the envelope.

The magnitude of the constricting force may be changed by the application of different pressure differences across the envelope. Because the magnitude of the constricting force may determine the stiffness of the jammable apparatus when jammed, the stiffness of the jammable apparatus in use may be varied by changes in the magnitude of the applied pressure difference.

The pressures within and/or outside of the envelope may be provided by any fluid. In at least some examples, the pressure both inside and outside of the envelope may be provided by an air pressure. In other examples, the pressure inside the envelope may be provided by a gaseous vacuum, for example the vacuum of space. In some examples, the pressures inside and outside of the envelope may be provided by different fluids.

The envelope may be conformable, so that the envelope may change shape in response to the application of the pressure difference. Where a shape of the components of the jammable apparatus within the envelope changes, the envelope may conform to the changed shape of the components.

The envelope may for example be flexible. The envelope may be elastically flexible. In other examples, the envelope may be flexible yet inelastic.

The components of the apparatus within the envelope may be or may include an assembly that includes rotatably associated members (also referred to herein as “rotation members”). One or more of the members can rotate relative at least another one of the members. The assembly that includes rotatably associated members can be rearranged between a first assembly shape (also referred to herein as “a first assembly position”) and a second assembly shape (also referred to herein as “a second assembly position”). The rearranging is by rotatable movement of one or more of the members relative to each other (or one another).

The members of an assembly may in some examples be referred to as links, such that the assembly includes a linkage of rotatably associated links. The links of the linkage may be pinned together, to provide a linkage of pinned members.

In some examples, the rearranging may comprise an articulation of the assembly.

The first assembly shape corresponds to a first apparatus shape. The second assembly shape corresponds to a second apparatus shape. The first and second apparatus shapes are shapes assumed by the apparatus corresponding to the first and second assembly shapes, respectively. That is, the apparatus is configured to assume a shape dependent on that of the assembly of members.

Jamming may begin to occur in a jammable apparatus upon the generation of a relatively reduced pressure inside the envelope, and the resulting constricting force that is exerted by the envelope. The constriction of the envelope against the components of the apparatus inside the envelope will begin to increase the frictional and kinematic engagement of the envelope with the components and any discrete components with each other.

The envelope may be formed with an opening or port adapted for fluid communication with, for example, a vacuum source for the application for the vacuum pressure.

Where an assembly that includes rotatably associated members is provided within the envelope of a jammable apparatus, the constricting force may act, either directly or indirectly, against the members.

The exertion of the constricting force may cause the rearranging of the members of an assembly of a jammable apparatus to or at least towards a particular shape. For example, the constricting force may cause the rearranging of the members of an assembly away from the first assembly shape and towards the second assembly shape. Where the assembly is not in the second assembly shape and is between the first assembly shape and the second assembly shape, the exertion of the constricting force may cause the assembly to rearrange to or towards the second assembly shape. For example, upon the exertion of the constricting force the assembly may be in the first assembly shape, and the assembly may then be rearranged to or towards the second assembly shape. Where the assembly is in the second assembly shape at the exertion force, the assembly would be maintained in the second assembly shape. In other words, the constricting force causes the assembly to rotatably articulate, rearrange, or move away from the first assembly shape and toward the second assembly shape where the assembly is positioned at the first assembly shape or between the first and second assembly shapes. With such a configuration, the assembly is configured to rotatably move away from the first assembly shape and towards the second assembly shape in response to the constricting force where the assembly is positioned at the first assembly shape or between the first and second assembly shapes. Furthermore, the constricting force causes the assembly to maintain the second assembly shape where the assembly is positioned at the second assembly shape.

When the rearranging of the members of the assembly due to the constricting force ceases at the second assembly shape, the frictional and kinematic engagement of the envelope with its contents and any frictional and kinematic engagement parts of the contents of the envelope with each other may increase in the continued presence of the constricting force, and the apparatus may be said to assume a fully jammed condition.

In a fully jammed condition, a jammable apparatus may have its greatest stiffness for any given pressure that is applied across the envelope. The fully jammed condition may be associated with a rearranged condition of the assembly such that its volume within the envelope is minimised. In some examples this rearranged condition may be the second assembly shape.

The assembly may cease rearranging once it is in the second assembly shape. In other situations, the assembly may cease rearranging before it is in the second assembly shape state due to a resistive force. Such a resistive force may for example be or include a frictional force which resists the rotation of a member or members of the assembly such as would allow the assembly to rearrange to the second assembly shape. Such a resistive force may for example be or include an external force acting on the jammable apparatus to resist the changing shape of the assembly. Where resistive forces prevent the rearranging of the members of the assembly entirely to their second shape, the apparatus may still be jammed under the influence of the constricting force. That is, with such a configuration, the assembly may experience a less of a jamming effect (reduced jamming) at the shape (or position) where the assembly ceases changing shape due to the resistive force. The amount of stiffness imparted to the assembly in such a case may be less than that imparted to the assembly in a fully jammed condition at the second assembly shape in the absence of the resistive forces.

Where resistive forces limit the rearranging of an assembly to the second assembly shape, a reduction in or the removal of the resistive forces may result in continued rearrangement of the assembly to or towards the second assembly shape. Similarly, where resistive forces exist that have limited the rearrangement of the assembly, an increase in the constricting force exerted by the envelope may overcome the resistive forces and cause a continued rearrangement of the assembly to or towards the second assembly shape.

An assembly that includes rotatably associated members may have an expanded state and a collapsed state. The assembly may be in the collapsed state when it is in the second assembly shape. The assembly may be in its expanded state when it is rearranged away from the second assembly shape. More particularly, the assembly may be in its expanded state when it is in the first assembly shape. The constricting force may act, either directly or directly, on the members of the assembly that includes rotatably associated members to rearrange it to or towards its collapsed state.

Where the shape of the assembly confers a shape to the jammable apparatus, the expanded state and collapsed state of the assembly may be associated with different shapes of the jammable apparatus. For example, when the assembly is in its expanded state, the jammable apparatus may be in the first apparatus shape. When the assembly is in its collapsed state, the jammable apparatus may be in the second assembly shape.

As the rearranging of the members of an assembly may cause a change in shape of the assembly and consequently of the jammable apparatus itself, jammable apparatus having an assembly that includes rotatably associated members may be utilised as an actuator. Where an assembly is configured to rearrange to or towards the second assembly shape, the second assembly shape and resulting second apparatus shape of the jammable apparatus will define the actuated shape of the jammable apparatus.

Where a jammable apparatus provides an actuation upon the exertion of the constricting force, the jammable apparatus may move between an expanded state and a compressed state. As a jammable apparatus moves between the expanded state and the compressed state, a dimension of the assembly of the jammable apparatus may change. For example, a height of the assembly at one or more locations along its length may decrease. However, because of the rotatable associations of the members, the decrease in height of the assembly at one or more locations along its length results in an additional change in shape of the assembly. In at least some preferred configurations, the rearranging of an assembly from the first assembly shape to the second assembly shape comprises a change in more than one of a width, a height, and a length in respective dimensions of the assembly at one or more locations between its ends. Consequently, in at least some preferred configurations, when an assembly rearranges between the first assembly shape and the second assembly shape, a jammable apparatus which comprises the assembly actuates from the first apparatus shape to the second apparatus shape, and the actuation comprises more than a change in a height of the jammable apparatus at one or more locations along its length. In addition to a change in a height of the jammable apparatus at one or more locations along its length, a curvature of the jammable apparatus along its length may change between the first apparatus shape and the second apparatus shape.

In at least some examples, the rotatable associations between members of an assembly may be non-biased rotatable associations. For example, members may be pinned to each other so that they can rotate relative to each other, and the pinned connections may not themselves confer a biased rotational arrangement of the members relative to each other.

An assembly may have a biased shape, to or towards which the assembly is urged by a returning force in the absence of the exertion of the constricting force, or in the presence of the exertion of the constricting force below a particular threshold. That is, in the absence of the constricting force exceeding the threshold, the assembly may be biased to or towards the biased shape by the returning force.

Where an assembly rearranges towards the second assembly shape upon the exertion of the constricting force, the assembly may be biased either to the second assembly shape or to another shape. For example, particularly where a jammable apparatus is to provide an actuating function, its assembly may be biased away from second assembly shape or more particularly to the first assembly shape. In this arrangement, an exertion of the constricting force operates the assembly from the first assembly shape to the second assembly shape, and consequently the jammable apparatus from the first apparatus shape to the second apparatus shape, thereby providing an actuation. In other examples, an assembly may be biased to or towards its actuated shape. For example, an assembly which rearranges towards the second assembly shape upon the exertion of the constricting force may be biased to or towards the second assembly shape. In this arrangement, the exertion of the constricting force from the biased shape of the assembly may provide minimal or even no actuation of the assembly and consequently of the jammable apparatus.

In some examples, the biasing of an assembly may be provided by an external biasing of the assembly to a predetermined shape. In other examples, the biasing may be provided by the assembly itself. In still other examples, the biasing may be provided by both the assembly itself and by external biasing of the assembly.

While some arrangements of a jammable apparatus may include an assembly which has a biased shape, in other arrangements a jammable apparatus may be, in the absence of the constricting force, unbiased to any particular shape.

One or more of the members of an assembly that includes rotatably associated members may include a distal extension past a point of rotation of the member which defines and is operable as a lever arm. A member may include only one lever arm. In other examples, a member may include more than one lever arm. For example, a member may include two lever arms, one towards each of two distal ends of the member.

A rearranging of one or more of the members of an assembly that includes rotatably associated members may move one or more of the lever arms relative to other members of the assembly. In different rearranged conditions, one or more of the lever arms may be located either relatively more or less proximately to other adjacent members. For example, in the first assembly shape one or more of the lever arms may project outwardly of the assembly more so than in the second assembly shape.

The one or more lever arms of an assembly that includes rotatably associated members may be acted on by the constricting force. The action of the constricting force upon the lever arms may cause the assembly to rearrange from an expanded state to a relatively more collapsed state. As the constricting force is exerted on the lever arms, the members may be caused to rotate relative to each other, resulting in a change of shape of the assembly.

The action of the constricting force on lever arms of an assembly may be associated with a change in a dimension of the assembly. For example, the action of the constricting force may cause a reduction in a dimension of the assembly. Where an assembly has a width, a length, and a height, the constricting force may provide a change in of the width, length, and height dimensions of the assembly. In some examples, the exertion of the constricting force may provide a change in only one of these dimensions.

The lever arms of an assembly may be moveable in one direction as the assembly rearranges. For example, the lever arms may be extended from or retracted towards a first side of the assembly as the assembly rearranges between different shapes. In some examples, all the lever arms of an assembly may extend from or retract towards the first side of the assembly as the assembly rearranges between different shapes.

The lever arms of an assembly may in other examples be extended from or retracted towards either the first side or a second opposed side of the assembly as the assembly rearranges between different shapes. In some examples, all the lever arms of an assembly may be extended from or retracted towards either the first side or the second side of the assembly as the assembly rearranges between different shapes.

In examples where the lever arms of an assembly are either extended from or retracted towards one of two opposed sides of the assembly as it rearranges between different shapes, a rearranging of the assembly towards the second assembly shape may involve a compression of the assembly in one dimension. The dimension may be taken perpendicularly to either side of the assembly at a given location.

As the constricting force acts on the lever arms to compress the assembly, one or more of the lever arms may be rotatably retracted towards the assembly. In some examples, one or more of the lever arms may be rotatably retractable to lie at least partially within the assembly. In other examples, one or more of the lever arms may be rotatably retractable to lie substantially entirely within the assembly. In still other examples, each of the lever arms of an assembly may be rotatably retractable to lie entirely or substantially entirely within the assembly.

Where a lever arm is rotatably retracted towards the assembly to lie at least partially within the assembly, an overlap of the lever arm with at least one adjacent member may be increased.

The outwardly projection of the lever arms of an assembly may provide the side of the assembly from which they project with a relatively uneven surface. When the lever arms are retracted, their retraction may provide the side of the assembly where they have retracted with an even or at least relatively continuous surface.

The members of an assembly may longitudinally extend past each other so that they longitudinally overlap with each other. For example, members of an assembly may include one or more lever arms distal of their relative point or points of rotation, and the lever arms of adjacent members may longitudinally overlap with each other.

Because the members are relatively rotatable, the portions of respective members which extend longitudinally past each other may be moveable between relatively more or relatively less contiguously aligned states. For example, where one or more members of an assembly have one or more lever arms, the rotation of the members may cause the lever arms to move and either increase or decrease the contiguous alignment of the members with each other.

The reconfiguration of the members of an assembly of a jammable apparatus between the first assembly shape and second assembly shape may provide a change in how contiguously the members are aligned relative to each other. For example, in the second assembly shape a member of the assembly may be relatively more contiguous with adjacent members than in the first assembly shape. As an assembly rearranges from the first assembly shape towards the second assembly shape, a degree of contiguity of at least one of the members increases.

When the members of an assembly are relatively less contiguously aligned, for example with lever arms projecting outwardly of the assembly in a first assembly shape, the assembly may be in its expanded state. Conversely, when the members of an assembly are relatively more contiguously aligned, for example with lever arms retracted in a second assembly shape, the assembly may be in its compressed state. A compressive force exerted on an assembly by an envelope it is provided within may operate to urge its members into relatively greater contiguous alignment with each other, from the expanded state to the compressed state of the assembly.

The members of an assembly may have a fully contiguous state, in which each member of the assembly is rotatably arranged to be contiguous with adjacent members. In this arrangement, the arrangement of the members of the assembly in the second assembly shape is closer to the contiguous state of the members of the assembly than is the arrangement of the members in the first assembly shape.

In some examples, in the second assembly shape each member of an assembly may be contiguous with adjacent members of the assembly. In the first assembly shape, each member of an assembly may be non-contiguous with adjacent members of the assembly.

The relative contiguity of adjacent members with each other may be a relative contiguity at one side of an assembly. For example, the relative contiguity of adjacent members with each other may be a relative contiguity at a first side of the assembly at which one or more lever arms extend and retract between the first assembly shape and second assembly shape. In other examples, the relative contiguity of adjacent members with each other may be a relative contiguity at both the first side and a second side that is opposed to the first side.

The relative contiguity of adjacent members may be a relative contiguity of a given member with longitudinally adjacent members, along a longitudinal direction of the assembly. The relative contiguity of members may be a relative contiguity of a given member with laterally adjacent members, along a lateral direction of the assembly. The relative contiguity of adjacent members may be relative contiguity of a given member with both longitudinally and laterally adjacent members.

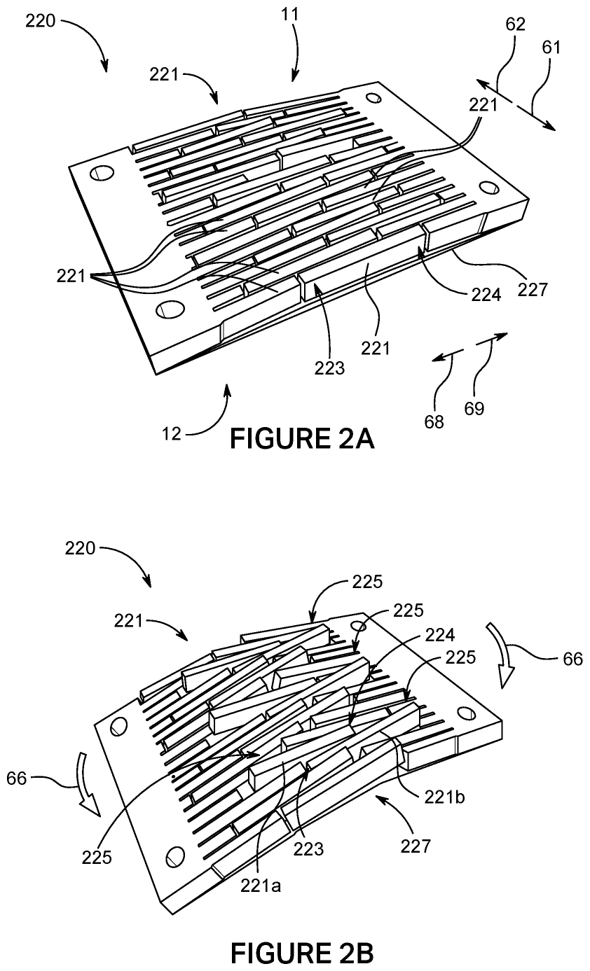

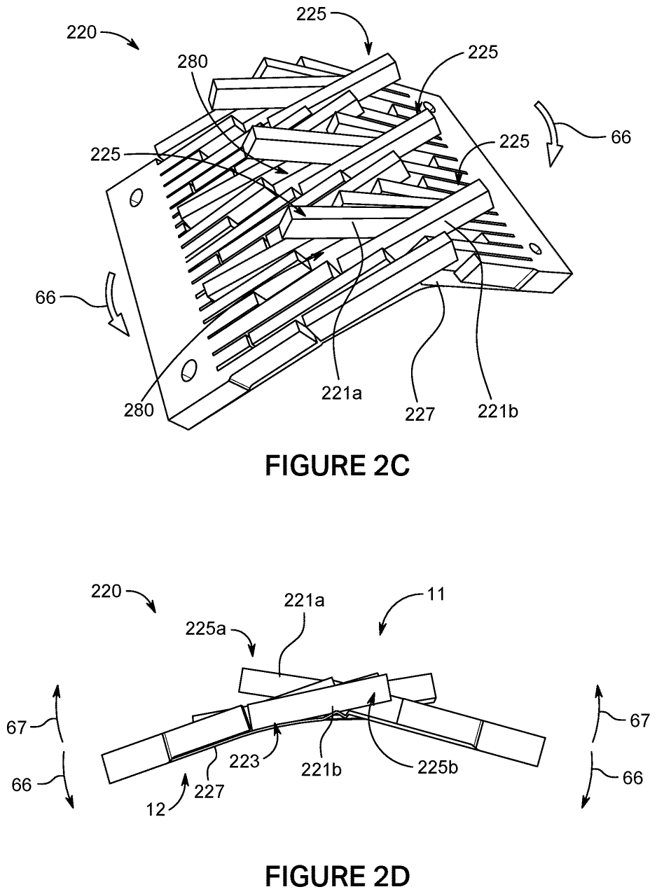

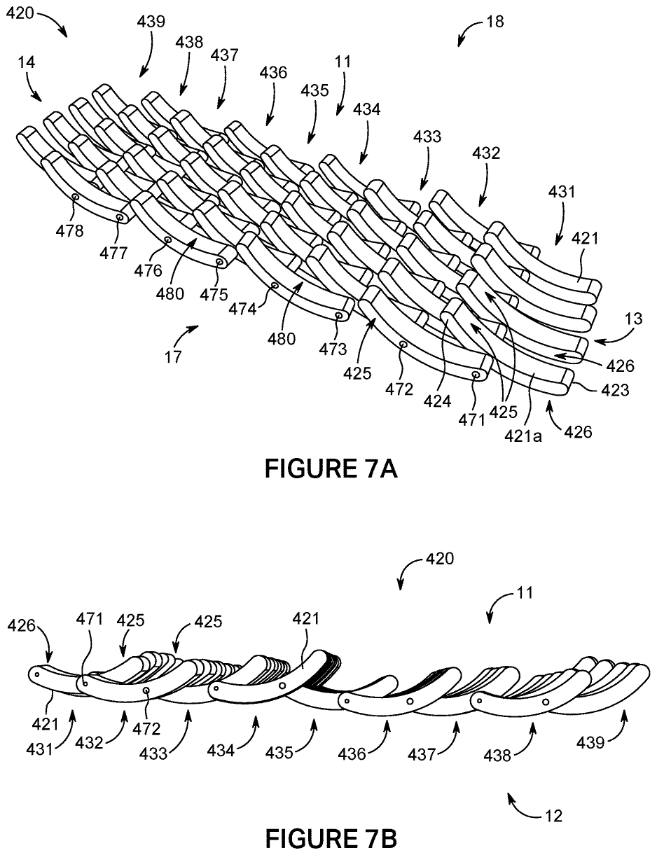

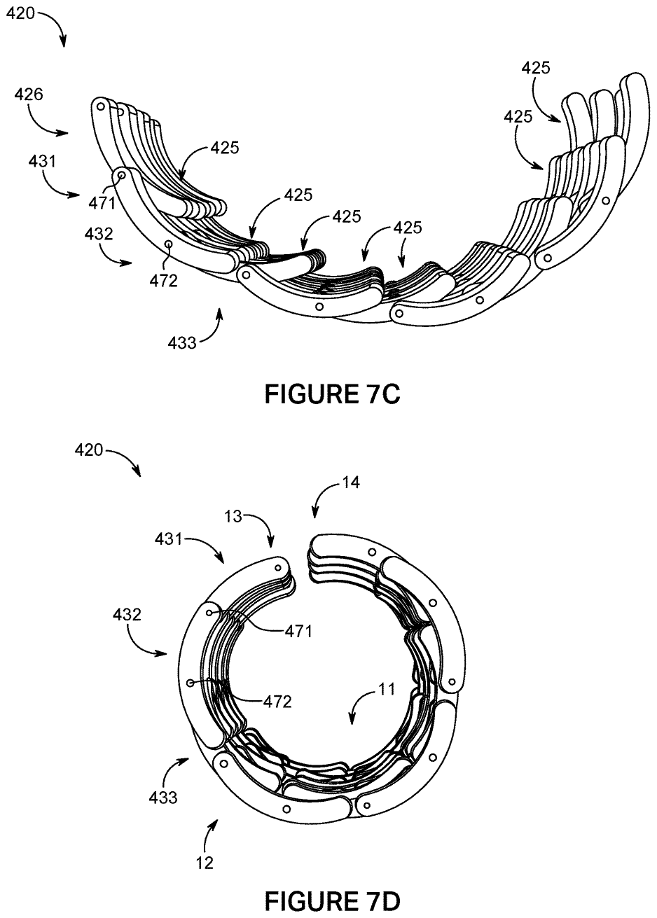

In some examples, an assembly which has members that become increasingly contiguously aligned with each other towards the second assembly shape may be flat in the second assembly shape. An example of this is illustrated in and will be described in relation to FIGS. 2A-2D. In other examples, assembly which has members that become increasingly contiguously aligned with each other towards the second assembly shape may be non-flat, for example curved, in the second assembly shape. An example of this is illustrated in and will be described in relation to FIGS. 7A-7D.

Where the members of an assembly increase in their contiguity, a continuousness of a surface of the assembly may increase. For example, as an assembly rearranges from the first assembly shape to the second assembly shape, a surface of the assembly at the first side of the assembly may become more continuous. In a first assembly shape where the members are arranged relatively less contiguously, the surface at the first side of the assembly may be relatively discontinuous, having one or more lever arms projecting outwardly. In a second assembly shape where the members are arranged relatively more contiguously, the surface at the first side of the assembly may be relatively more continuous, having one or more lever arms retracted within the assembly.

In some examples, the continuousness of a surface at both the first side of the assembly and an opposite second side of the assembly may increase as the members of an assembly increase in their degree of relative contiguity.

When the continuousness of a surface of the assembly increases, the contact area of that side of the assembly with an adjacent component of the jammable apparatus may also increase. An increased contact area of the assembly with an adjacent component or components of the jammable apparatus may be associated with increased frictional engagement therebetween. Accordingly, the stiffness of the jammable apparatus may be increased when it is jammed in the second assembly shape with one or more relatively more continuous surfaces than in the first assembly shape.

Where an assembly has contiguously aligned members, the assembly may include one or more voids through a height of the assembly between the first and second opposed sides of the assembly. Where an assembly has a continuous surface at one or both of the first and second opposed sides of the assembly the assembly may include one or more voids through a height of the assembly or between the first and second opposed sides.

In some examples the members of an assembly that includes rotatably associated members may be arranged in a two-dimensional array. In their two-dimensional array, the members are arranged both laterally adjacent to each other and longitudinally adjacent to each other. The rotation of a member having a lever arm relative to one or more of the other members may move the lever arm in a third dimension, being a dimension perpendicular to each of the other two dimensions of the array. The rearrangement of the assembly between a first assembly shape and a second assembly shape may change the size of the assembly in the third dimension. For example, in the first assembly shape it may have a first size in the third dimension, and that size may reduce as the assembly rearranges to the second assembly shape. The size of the assembly in the third dimension may be at its minimum when the assembly is in the second assembly shape.

The size in the third dimension may be taken as a maximum extent of the assembly in that dimension. In other examples, the proportion in the third dimension may be taken within a notional envelope encompassing the assembly.

In some examples an assembly may be characterised as having a notional surface bounding one side of the assembly. As the lever arms are retracted towards the assembly during its rearrangement from the first assembly shape to the second assembly shape, the spacing or a mean spacing of the notional surface from a centre of the assembly reduces.

In other examples an assembly may be characterised as having a pair of notional surfaces bounding two opposed sides of the assembly. As the lever arms are retracted towards the assembly during its rearrangement from the first assembly shape to the second assembly shape, the spacing or a mean spacing of the notional surfaces from each other reduces.

In other examples, the action of the constricting force on the lever arms of an assembly may result in a change in more than one dimension of the assembly.

In some examples, a jammable apparatus may include an intermediate component also provided within the envelope. The intermediate component may be provided between an assembly and the envelope of the jammable apparatus.

In some examples, an intermediate component may be configured to facilitate movement (e.g., articulation) of the assembly between the first assembly shape (position) and the second assembly shape (position).

In some examples, an intermediate component may be configured to be slidably movable relative to the envelope during rearranging of the assembly.

In some examples, an intermediate component may be configured to be slidably moveable relative to the assembly during rearranging of the assembly. To this end, an intermediate component may provide a lower coefficient of friction of the members against the intermediate component than the envelope against the members. This may assist in the articulation of the assembly between the first assembly shape and second assembly shape. In such examples, the intermediate component may thus be considered to have a sliding surface configured to facilitate slidable movement of the assembly thereon.

In some examples, an intermediate component may additionally alternatively have greater resistance to local deformation than the envelope. The intermediate component may thus be understood to be configured to resist local deformations resulting from contact with the lever arms of the assembly. Using such an intermediate component prevents engagement of the lever arms of the assembly against the envelope that would otherwise inhibit or hinder articulation of the assembly.

In some examples, an intermediate component may additionally or alternatively bend elastically as the assembly articulates. The elastic bending (or the resilient bending) of the intermediate component may provide a returning force to (or exert a returning force on) either the assembly and/or the envelope, and so act to bias the assembly back towards a biased shape of the intermediate component. With such a configuration, in some examples, the intermediate layer is configured to resiliently exert a returning force to cause the assembly to move away from the second assembly position and toward the first assembly position in the absence of the opposing constricting force greater than the returning force. In another interpretation, the intermediate layer is configured to resiliently exert a returning force to cause the assembly to move away from the second assembly position and toward the first assembly position in response to the constricting force being smaller than the returning force. Such configurations may accordingly provide a jammable apparatus with a biased shape, from which the jammable apparatus actuates upon the exertion of the constricting force.

In some examples, an intermediate component may additionally or alternatively be resistant to puncturing to thereby reduce the susceptibility of the envelope to puncturing due to pressure of the lever arms. That is, the employment of the intermediate component in these examples may improve the resistance of the envelope to puncturing caused by the lever arms, which improves durability.

In some examples, an intermediate component may be provided between only part of the assembly and the envelope. For example, the intermediate component may be provided at one side of the assembly. In other examples, an intermediate component or multiple intermediate components may be provided between the assembly and the envelope. The multiple intermediate components may be provided between the same part of the assembly and the envelope, or between different parts of the assembly and the envelope. For example, a first intermediate component may be provided between one side of the assembly and the envelope, and a second intermediate component may be provided between another opposite side of the assembly and the envelope. Where an intermediate component or intermediate components are provided between an assembly and an envelope, the intermediate component or intermediate components may be provided so that when lever arms of the assembly project outwardly of the assembly they project towards the intermediate component or intermediate components.

In some examples, an intermediate component or intermediate components may have a sheet-like form and may accordingly be characterised as an intermediate layer or intermediate layers.

Where an assembly is able to rearrange between a first assembly shape in which lever arms of members of the assembly project outwardly and a second assembly shape in which lever arms of members of the assembly are relatively retracted or are relatively more contiguous with adjacent members of the assembly, the shape of the members may be arranged to provide the assembly with a desired second assembly shape. As the second assembly shape corresponds to a second apparatus shape of a jammable apparatus that includes the assembly, and the jammable apparatus is in the second apparatus shape when a constricting force is exerted, the shape of the members may be arranged to determine an active or actuated shape of the jammable apparatus.

FIGS. 2A-D which will subsequently be described illustrate a configuration of an assembly 220 for a jammable apparatus where the members 221 are all straight or non-curved, such that the second assembly shape of the assembly, as illustrated in FIG. 2A, is flat.

FIGS. 7A-D which will subsequently be described illustrate a configuration of an assembly 420 for a jammable apparatus where the members 421 are all curved. The curved shape of the members 421 means that when the lever arms of the members are retracted, so that adjacent members 421 are relatively more or entirely contiguous with each other, the assembly 420 has a non-flat and more particularly a curved shape. The assembly 420 in the second assembly shape is illustrated in FIG. 7D. While each of the members 421 of the assembly 420 of FIG. 7D are curved, in other configurations an assembly may include both curved and non-curved members to provide a desired second assembly shape of an assembly.

Accordingly, by selection of the shape of the members of an assembly, and the arrangement of differently shaped members within the assembly, the compressed state and second assembly shape of an assembly, and thus the second apparatus shape that a jammable apparatus is operated to when a constricting force is exerted on its envelope, may be mechanically programmed. The selection and arrangement of the shape of members of an assembly may allow the actuated shape of a jammable apparatus to be selectively controlled.

Where an intermediate component is provided between an assembly and an envelope in a jammable apparatus, and the intermediate component has a biased shape towards which the intermediate component is biased to return in the absence of a constricting force, the first assembly shape and corresponding first apparatus shape may be determined by the selection of the intermediate component and its biased shape. The use of one or more intermediate components and their biased shapes may allow the non-actuated or passive shape of a jammable apparatus to be selectively controlled.

By combining both a) the selection of one or more intermediate components and their biased shapes and b) the mechanical programming of the assembly by selection of the shape and arrangement of the members of the assembly, both the first apparatus shape and second apparatus shape of a jammable apparatus may be selected. Where a jammable apparatus is utilised as an actuator, both the unactuated and actuated shapes of the actuator are therefore able to be selected for mechanically programming the assembly.

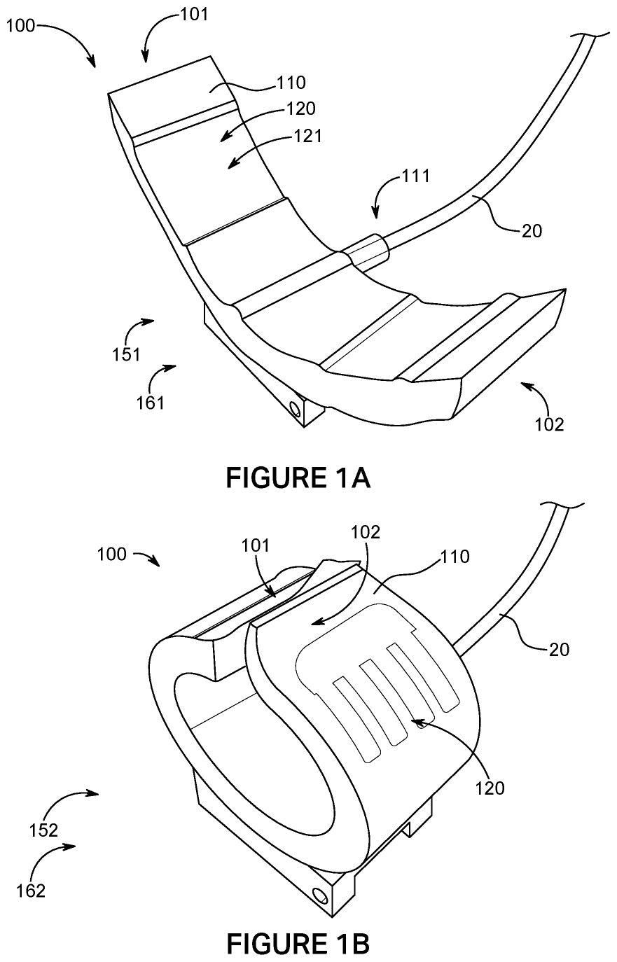

FIG. 1A shows an embodiment of a jammable apparatus 100. The jammable apparatus 100 has an envelope 110, within which an assembly 120 that includes members 121 (not visible in FIG. 1) is provided. The members 121 are rotatably associated with each other, which is discussed in detail below. The envelope 110 defines a closed system such that a relatively greater pressure can be provided at an outside of the envelope 110 than within an inside of the envelope. That is to say, the closed system is provided to enable a pressure outside the envelope 110 to differ from a pressure inside the envelope 110.

As shown in FIG. 1A, the envelope 110 has an opening 111 for communication with a vacuum source 20. A reduction in the pressure within the envelope 110 may be provided by the vacuum source 20 to create a pressure difference between the inside and the outside of the envelope 110. In other arrangements, the relative pressure difference may additionally or alternatively be applied between the inside and the outside of the envelope by an increase in the pressure on the outside of the envelope 110.

When the pressure outside of the envelope is not greater than inside the envelope, a jammable apparatus may be said to be at rest, or in a non-actuated state or a non-jammed state.

While the envelope 110 in FIG. 1A is illustrated in an air environment and the pressure difference between the inside and outside of the envelope 110 is a difference in the air pressure, a jammable apparatus may be utilised in other non-air fluids. That is, the same fluid or different fluids may be provided inside and outside the envelope 110 and controlled in the manner described above to introduce the pressure difference.

As shown in FIG. 1A, the assembly 120 is in a first assembly shape 151, such that the jammable apparatus 100 assumes a corresponding first apparatus shape 161. When the jammable apparatus 100 is in the first apparatus shape 161, the pressure differential between the inside and outside of the envelope is insufficient to generate a constricting force by the envelope on its contents and actuate the assembly 120 towards the second assembly shape. In this state the pressure within the envelope and pressure outside of the envelope may be equal or substantially equal.

As seen in FIG. 1B a sufficient pressure difference has been applied between the inside and the outside of the envelope 110 by the vacuum source 20. The pressure difference between the inside and the outside of the envelope 110 has caused the envelope 110 to exert a constricting force on the contents of the envelope. The constricting force has acted on the assembly 120, which has rearranged to a second assembly shape 152 as illustrated in FIG. 1B. The rearranging of the assembly 120 into the second assembly shape 152 has caused the jammable apparatus 100 to assume a corresponding second apparatus shape 162.

The exertion of the constricting force also causes the jammable apparatus 100 to become jammed, providing an increase in its stiffness.

As can be understood from FIGS. 1A and 1B, the transition of the jammable apparatus 100 from the first apparatus shape 161 to the second apparatus shape 162 causes a first end 101 and a second end 102 of the jammable apparatus 100 to be actuated towards each other. In FIG. 1B the first end 101 and the second end 102 have been brought into contact with each other. This functionality may have applications in, for example, robotic end effectors which are to, in use, grasp an object. The actuating functionality of the jammable apparatus 100 is provided by the change in shape of the assembly 120 between the first assembly shape 151 and the second assembly shape 152 under the influence of the constricting force by the envelope 110. The actuation of jammable apparatus 100 between the first apparatus shape 161 and the second apparatus shape 162 is also enabled by the initial state of the jammable apparatus 100 in the first apparatus shape 161 as seen in FIG. 1A. The jammable apparatus 100 may be manually operated to move, articulate, or transition to the first apparatus shape 161, and after being actuated to the second apparatus shape 162 may require an opposite manual operation to move, articulate, or transition back to the first apparatus shape 161. In other examples however, the assembly 120 may be biased to the first assembly shape 151 so that the jammable apparatus 100 is biased to the first apparatus shape 161, as seen in FIG. 1A. The exertion of a sufficient constricting force overcomes the biasing and, through the rearrangement of the assembly 120, transitions the jammable apparatus 100 to the second apparatus shape 162 from the first apparatus shape 161.

Where the jammable apparatus 100 is biased to the first apparatus shape 161, upon the cessation of the constricting force or at least its reduction so that it may be overcome by the biasing, the assembly 120 may return towards the first assembly shape 151, so that the jammable apparatus 100 returns towards the first apparatus shape 161. That is, upon the cessation of the constricting force, the assembly 120 may return to the first assembly shape 151 and the jammable apparatus 100 may accordingly return to the first apparatus shape 161.

Further examples of arrangements of an assembly that includes rotatably associated members for use in a jammable apparatus will now be described.

In some examples, the members of an assembly may be rotatably associated with each other by pinned connections between the members.

In other examples, the members of an assembly may be rotatably associated with each other by partial connection of the members to a base. When the base bends away from the side with the members connected to it, some of the members may be rotated relative to each other by their connection to the base. As the members are only partially attached to the base, an end or ends of the members may be displaced away from the base. For each member, a lever arm may be defined between the respective partial attachment and each end of the respective member. Where the member has one end distal from the partial attachment, the member defines a corresponding lever arm. Where the member has a plurality of ends distal from the partial attachment, the member defines corresponding lever arms.

FIG. 2A shows an assembly 220 that includes rotatably associated members 221 for use in a jammable apparatus. The assembly 220 includes a plurality of members 221. The members 221 each have a first end 223 and a second end 224. The members 221 are arranged in a two-dimensional array, with members 221 arranged in the opposite longitudinal directions 68 and 69 (see FIG. 2A) and in the opposite lateral directions 61 and 62 (see FIG. 2A).

The assembly 220 includes a base 227 (e.g., a base layer). The plurality of members 221 are provided on a first side of the base 227. The base 227 may have the members 221 mounted to it, more particularly mounted onto a surface of the base 227. The base 227 may be flexible, so that it can bend. The base may be resistant to in-plane deformation. In other examples, the base may be able to be deformed in-plane as well as bending.

The members 221 are each partially attached to the base 227. As illustrated in FIG. 2A, the members 221 are each partially attached to the base 227 at a portion towards one or the other of their respective first end 223 and second end 224.

The portion of each member 221 between the part which is attached to the base 227 and the other end of the member defines a lever arm 225. Because the members 221 at the lever arms 225 are not attached to the base 227, if the base 227 bends in a direction away from the members 221, one or more of the members 221 will be caused to rotate relative to one or more of the other members 221.

FIG. 2B shows the assembly 220 where the base 227 has been slightly bent in the direction 66 away from the members 221. As seen in FIG. 2B the bend is predominantly a localised bend occurring at or towards a middle of the base 227. Due to the bend, the members 221 attached to the base 227 at and adjacent to the middle of the base 227 have been rotated relative to each other. For example, as seen in FIG. 2B, a first member 221a is rotated relative to a second member 221b.

Where the members 221 have been rotated due to the bending of the base 227, their lever arms 225 are displaced (e.g., angularly displaced) from the base 227. As seen in FIG. 2B, the lever arms 225 of the members 221 affected by the bending of the base 227 have begun to project outwardly of the assembly 220.

Where the lever arms 225 of an assembly 220 are rotated away from the base 227, the lever arms 225 may leave voids 280 within the assembly 220 (see FIG. 2C). The voids 280 may be present when the assembly is rearranged away from the second assembly shape. When an assembly 220 is rearranged from the first assembly shape towards the second assembly shape, the lever arms 225 may each pivot back into and fill the respective voids 280.

FIG. 2C shows the assembly 220 where the base 227 has been bent further away from the members 221 than is shown in FIG. 2B. As seen in FIG. 2C, the members 221 affected by the bending of the base 227 have rotated relative to others of the members, and the displacement of the lever arms 225 away from the base 227 has been increased. Because the lever arms 225 pivot about the region of connection of the member 221 to the base 227, the maximum displacement of the lever arms 225 from the base 227 occurs at a distal end of each member 221 away from its attachment point to the base 227.

FIG. 2A shows the assembly 220 is in a relatively compressed state while FIG. 2B or 2C show the assembly 220 in relatively expanded states. Accordingly, in the arrangement of FIG. 2A the assembly 220 may be characterised as being in a compressed state. In FIGS. 2B and 2C the assembly 220 may be characterised as being in increasingly expanded states.

The constricting force exerted by an envelope within which the assembly 220 is provided may operate to constrict the assembly 220. As shown in FIG. 2A, the assembly 220 may be in its collapsed state and the second assembly shape, to which the assembly 220 articulate, moves, or transitions when part of a jammable apparatus is operated on by the constricting force. Accordingly, in different examples as shown in FIGS. 2B and 2C the assembly 220 may be partially rearranged by the constricting force towards its compressed state and second assembly shape. For example, the assembly 220 may be partially rearranged with the constricting force through pressure difference applied by an operator or a user in the manner described heretofore.

As seen in FIG. 2A, the members of the assembly 220 are contiguously aligned with each other, having the lever arms 225 retracted towards the base 227 so that a surface of the assembly 220 at the first side 11 of the assembly 220 is substantially continuous (e.g., non-protruding), at least in comparison to the surface at the first side 11 of the assembly 220 in a first assembly shape, for example as illustrated in FIG. 2C. As the assembly 220 as shown in FIG. 2A is substantially flat in the second assembly shape, where the assembly 220 of FIGS. 2A-D has a continuous surface at the first side 11 the assembly 220 is also substantially flat.

In the second assembly shape with the continuous surface of the assembly 220 at the first side 11 as illustrated in FIG. 2A, overlapping extents of each of the members 421 in the longitudinal directions 68 and 69 are all contiguous with each other in a direction between the first side 11 and the second side 12 of the assembly 220.

As seen in FIG. 2B, the assembly 220 has a relatively less continuous surface (or a relatively discontinuous surface) at the first side 11, with at least some of the lever arms 225 rotated away from the base 227. Where the assembly 220 of FIGS. 2A-D has a non-continuous surface at the first side 11, the assembly 220 is not flat. For example, in FIG. 2B the assembly 220 has a non-continuous surface at the first side 11 of the assembly 220 and is not flat, being bent on the base 227 and having one or more projecting lever arms 225. In other words, the projection of the lever arms 225 results in increased discontinuity of the surface at the first side 11.

FIG. 2D shows a side view of the assembly 220 of FIGS. 2A-C. In FIG. 2D the assembly 220 is in a partially expanded state. The members 221a and 221b have been caused to rotate relative to each other on the base 227. Their respective lever arms 225a and 225b have been rotatably extended upwardly away from the base 227, so that they rotatably project away from the first side 11 of the assembly 220.

The projection of lever arms of an assembly outwardly of the assembly (or the outward projection of lever arms of an assembly away from the base) in an expanded state of the assembly may increase the volume occupied by the assembly within the envelope of the jammable apparatus. Because the constricting force urges a reduction in volume of the envelope, the sliding of the lever arms relative to the envelope or another adjacent component of the apparatus may allow the assembly to rearrange to reduce the effective volume occupied by the assembly within the envelope. In the case of FIG. 2, for example, an effective volume may be defined by a notional envelope about the assembly 220. The notional envelope extends between solid parts of the assembly and may include empty spaces between members of the assembly when the assembly is in an expanded state.

When a vacuum is applied within an envelope, it may be caused to conform to at least towards the notional envelope of the apparatus.

To reduce resistance that the envelope may pose to the changing shape of the assembly, the envelope of a jammable apparatus may be conformable.

However, a highly conformable envelope may conform to the ends (such as projecting ends of the lever arms) or wrap around to the undersides of the lever arms upon the application of a relatively reduced pressure within the envelope. These interactions may result in a jamming engagement between the envelope and lever arms that resists the rearrangement of the assembly towards the second assembly shape in which assembly occupies a reduced effective volume within the envelope. Accordingly, where the lever arms are in contact with the envelope of a jammable apparatus, the conformability of the envelope may be limited to prevent undesirable interactions with the lever arms that would inhibit the assembly changing shape.

An assembly that includes rotatably associated members which are connected to a base at one side of the assembly may allow bending in one direction, but resist bending in another opposite direction. For example, as illustrated in FIG. 2D the assembly 220 is reconfigurable to allow bending in the first bending direction 66. However, from its compressed state, in the configuration of FIG. 2D when the assembly 220 is flat, the assembly may resist bending in a second bending direction 67 opposite to the first bending direction 66.

The members 221 of the assembly 220 of FIGS. 2A-D are attached to the base 227 at one or the other of the ends 223 and 224 of each of the members. In the configuration of FIGS. 2A-D, some members 221 are attached to the base 227 at locations towards their first end 223, while the other members 221 are attached to the base 227 at locations toward their second end 224.

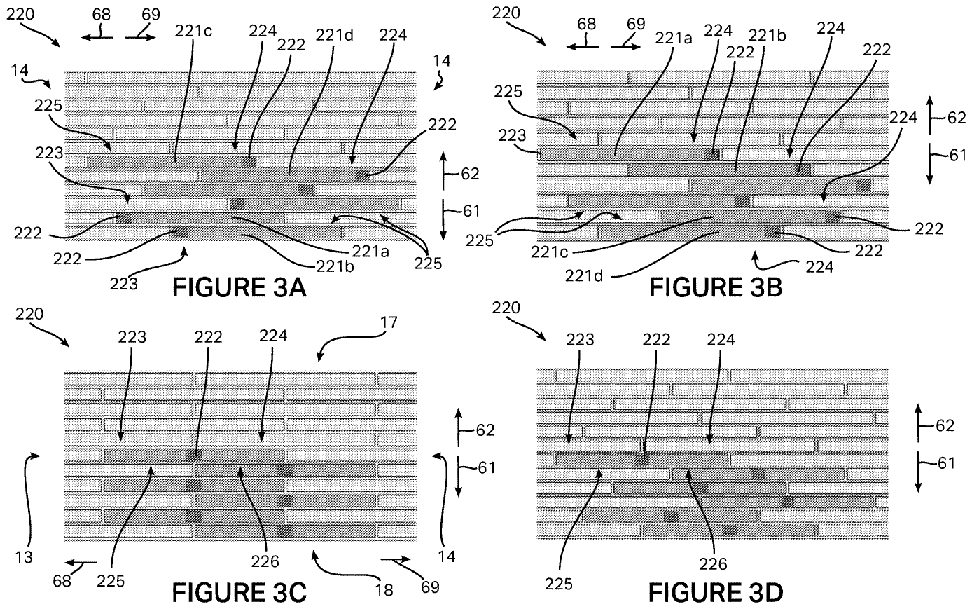

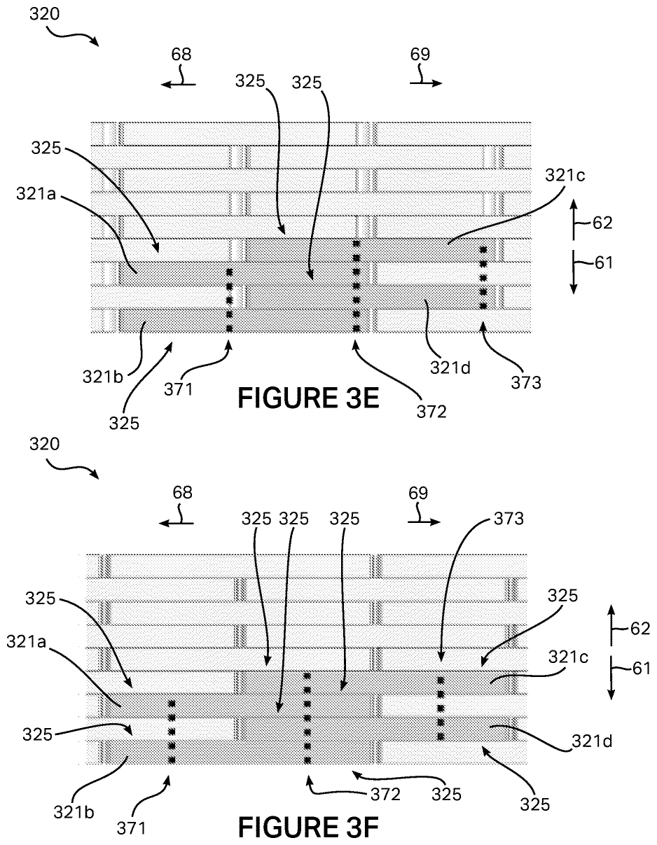

FIGS. 3A-D illustrate different arrangements of members 221 within an assembly 220, and different arrangements of the connection locations 222 (i.e., locations of attachment) between the members 221 and the base 227. In each of FIGS. 3A-D an assembly 220 including members 221 is shown, with a selected number of the members highlighted to illustrate the connection locations 222 at which they are partially connected to a base 227 (not visible in FIGS. 3A-D) of the assembly. In the examples of FIGS. 3A-D, each member 221 has a distal portion that is distal from the respective connection location 222 and that defines a respective lever arm. In other arrangements, each member may have more than one such distal portion and more than one such lever arm.

FIG. 3A illustrates an arrangement of an assembly 220 such as has been described in relation to FIGS. 2A-D. In the arrangement of FIG. 3A, adjacent members in the lateral directions 61 or 62, for example the members 221a and 221b, are offset from each other in the longitudinal directions 68 and 69, so that their respective ends are not aligned. Some of the members 221, for example members 221a and 221b, are attached to the base of the assembly at connection locations 222 towards their first ends 223. Others of the members, for example members 221c and 221d, are attached to the base of the assembly at connection locations 222 towards their second ends 224.

FIG. 3B illustrates another arrangement of an assembly 220. In FIG. 3B each of the members 221 of the assembly 220 are attached to the base 227 at connection locations 222 only at their second ends 224, as illustrated by the members 221a, 221b, 221c, and 221d. As seen in FIG. 3B, the second ends 224 of each of the members 221a-d towards which the members are connected to the base are each located towards a common end of the assembly 220.

The arrangements of FIGS. 3A and 3B each define a single lever arm 225 of each member, by the portions distal of each connection location 222. In the arrangement of FIG. 3A, the lever arms 225 of different members 221 extend from their respective connection locations 222 either towards the first end 13 or second end 14 of the assembly 220. In the arrangement of FIG. 3B, the lever arms 225 of the members all extend from their respective connection locations 222 towards the first end 13 of the assembly 220. In use, an arrangement as shown in FIG. 3A where some of the lever arms 225 extend in either longitudinal direction may result in sliding forces acting against an adjacent component of the jammable apparatus (for example an envelope or an intermediate component) in both longitudinal directions.

FIG. 3C illustrates another arrangement of an assembly 220. In FIG. 3C each of the members 221 are to be connected to the base 227 at the connection locations 222 towards a middle of each of the members. Because the connection locations 222 are away from each of the ends 223 and 224 of the members 221, each member defines a first lever arm 225 on one side of its connection location 222, and a second lever arm 226 at the other side of its connection location 222. In the configuration of FIG. 3C, adjacent members 221 in the lateral directions 61 and 62 are offset from each other in the longitudinal directions 69 and 69. Each member is longitudinally offset from a laterally adjacent member by half of its length. The longitudinal offsetting is such that the connection locations 222 of different rows of the members 221 are aligned with each other between the first lateral side 17 and the second lateral side 18 of the assembly 220 at different locations along its length between its first end 13 and second end 14.

FIG. 3D illustrates another arrangement of an assembly 220. The arrangement shown in FIG. 3D is similar to that of FIG. 3C, except that the longitudinal offsetting of laterally adjacent ones of the members 221 are different. In the arrangement of FIG. 3D, laterally adjacent rows of the members 221 are irregularly offset from each other. As in the configuration of FIG. 3C, each member 221 is to be connected to a base at a connection location 222 away from each end of the member, so that each member defines both a first lever arm 225 and second lever arm 226.

An assembly with members partially connected to a base may be configured to bend in one dimension along its length, for example as shown in FIGS. 2B-2D. That is, the members may each be partially connected to the base, with the respective points of partial attachment arranged toward a same side of the base. Such an assembly may be said to have one degree of freedom.

However, an assembly with members partially connected to a base may in some configurations also allow at least some degree of twisting of the assembly about an axis oriented along a longitudinal direction of the assembly. Such an assembly may be said to have two degrees of freedom.

An assembly may be configured to either inhibit (e.g. prohibit or block) or allow twisting in use. Where twisting is to be allowed, the ends of members of the assembly may be aligned along a diagonal angle (e.g., a diagonally extending imaginary line) between the first lateral side 17 and second lateral side 18 of the assembly. Where twisting is to be limited, or is to be inhibited, a degree of diagonal alignment of the ends of the members of the assembly may be reduced.

For example, as shown the configuration of FIG. 3B the ends of the members 221 are relatively less aligned along any diagonal of the assembly 220 than in the configuration of FIG. 3A. Accordingly, the assembly 220 of FIG. 3B may have a reduced ability (e.g., a reduced range of twisting movement) to twist about an axis oriented between its longitudinal first end 13 and second end 14 compared to the configuration of FIG. 3A.

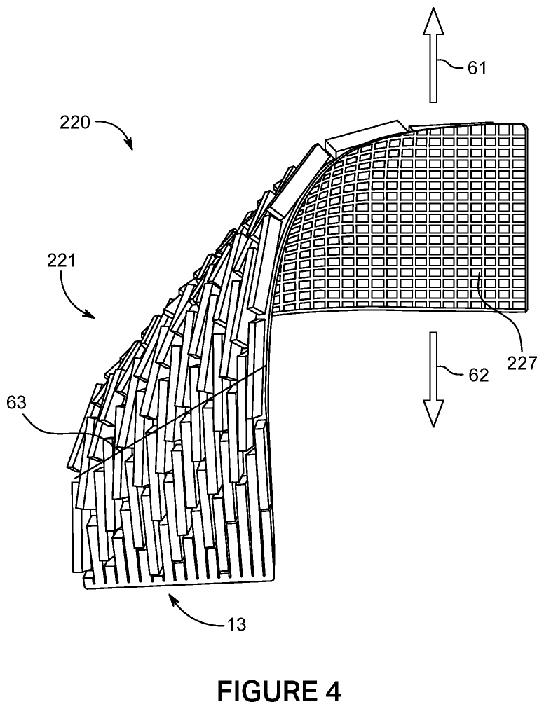

The ends of members may be fully or partially aligned along both of two diagonal directions between the lateral sides of an assembly. Accordingly, such an assembly may be able to twist, flexing in two dimensions towards either the lateral direction 61 or the lateral direction 62. An example of such an assembly 220 is shown in FIG. 4. The assembly 220 of FIG. 4 includes members 221, each partially connected to a base 227, with an arrangement of connection of the members as is illustrated and has been described in relation to FIG. 3A. The ends 223 of at least some the members 221 are at least substantially aligned across two opposed diagonal directions across the assembly. As shown in FIG. 4 the assembly 220 has been rearranged from a flat state by twisting of the base along successive diagonal lines 63 (only one shown in FIG. 4) of partial alignment of the ends 223 of the members, so the assembly 220 is curved in two dimensions and a first end 13 of the assembly 220 extends in the second lateral direction 62. In an unillustrated operation where the same assembly 220 is flexed along unshown successive diagonal lines opposite to the diagonal lines 63, the first end 13 of the assembly 220 in response extends in the first lateral direction 61.

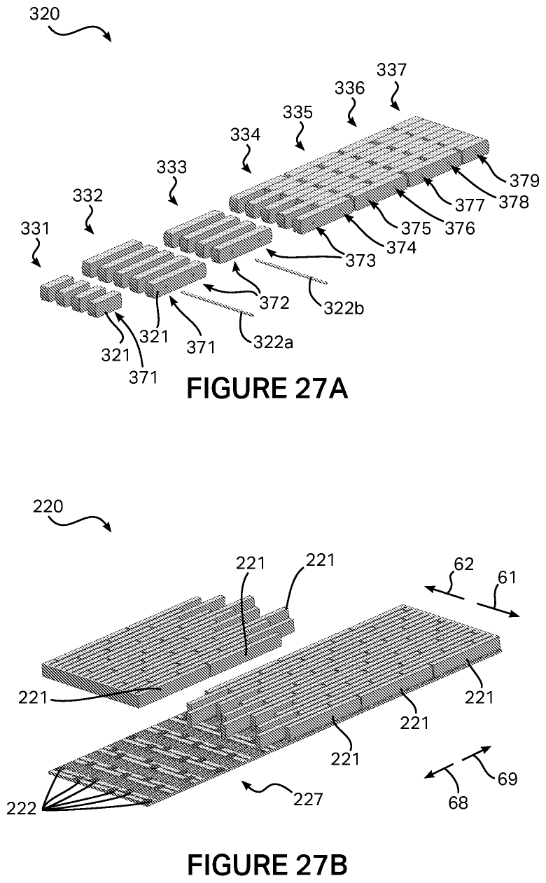

Symmetry of the longitudinal locations of the end of members of an assembly between the lateral sides of the assembly may act, in use, to inhibit twisting of the apparatus. For example, as seen in FIG. 27B the members 221 of the assembly 220 are arranged in the longitudinal directions 68 and 69 symmetrically between the two lateral sides of the assembly. Beginning from the lateral sides of the assembly, each laterally opposed pair of members 221 are longitudinally aligned.

Configurations of an assembly having members partially connected to a base which is able to flex in two degrees of freedom may, when incorporated within an envelope as a jammable apparatus, provide an apparatus with two degrees of freedom where its stiffness may be varied by jamming. In contrast, known implementations of elastomer bars to provide two degrees of freedom can achieve only a single, non-variable stiffness.

As can be understood from the relevant description herein, the arrangements with members partially connected to a flexible base as exemplified in FIGS. 3A-D are suitable for applications requiring two degrees of freedom, with one degree of freedom providing a bending movement and the other degree of freedom providing a twisting movement. For example, where implemented in an exoskeleton, the flexible arrangement as illustrated in FIGS. 3A-D may, by virtue of the two degrees of freedom, wrap and conform around the body of a user. In some example gripper finger implementations, the flexible nature imparted by two degrees of freedom allows for better conformance or compliance to different object shapes during grasping operations. In other example gripper finger implementations, a single degree of freedom may be desirable to provide comparatively greater strtuctural rigidity.

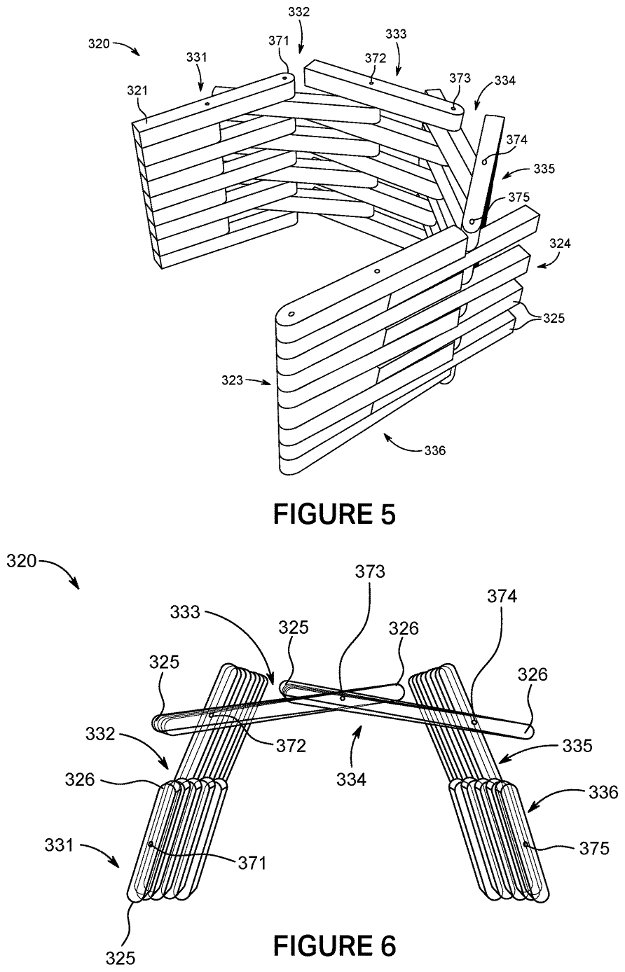

Compared to assemblies having members which are relatively rotatable by pinned connections (for example as shown in FIGS. 7A-D), an assembly with members partially connected to a side of a base of the assembly (for example as shown in FIGS. 2A-D) may be configured to provide more closely (or densely) spaced points of relative rotation. Relatively more closely spaced points of relative rotation of an assembly may be able to provide an increased ability for a jammable apparatus to conform to a desired shape. For example, as illustrated in the schematics of each of FIGS. 3A, 3B, and 3D, the connection locations 222 of the members 221 may be unaligned between members adjacent in the lateral directions 61 and 62. This may provide more closely adjacent pivoting locations along the length of the assembly than may be provided by an assembly having pinned members, such as that illustrated in FIG. 5 or 6.

As illustrated in the schematics of each of FIGS. 3A, 3B, and 3D, the connection locations 222 of the members 221 may be unaligned between members adjacent in the lateral directions 61 and 62. Conversely, as illustrated in FIG. 3C, the connection locations 222 are aligned along the lateral directions 61 and 62, so that successive connection locations 222 in the longitudinal directions 68 and 69 are relatively more spaced apart.

An assembly that includes relatively rotatable members configured as has been described in relation to FIGS. 3A and 4 can provide for different expanded arrangements of the assembly and thus different shapes of a jammable apparatus when the assembly is in the different expanded arrangements. For example, a jammable apparatus utilising the assembly 220 of FIG. 4 may be operable to a first non-compressed shape where the first end 13 of the assembly extends towards the second lateral direction 62, or a second non-compressed shape where the first end 13 of the assembly extends towards the first lateral direction 61. Such arrangements may consequently provide different actuations of a jammable apparatus upon the exertion of the constricting force.

While the assemblies 220 of FIGS. 3A-D are illustrated with members 221 of equal lengths, in other examples one or more of the members of an assembly for a jammable apparatus may be of different lengths.

Similarly, while illustrated in FIGS. 3A-D with the connection locations of each member either at an end of the member or away from an end of the member, in other examples the members of an assembly may include one or more members that have only one lever arm, and one or more members that have two lever arms.

It can thus be understood that in the arrangements of FIGS. 3A and 3B, each member 221 includes an attachment part (i.e., the respective connection location 222) fixed to the base and a non-attachment part rotatably moveable about the respective attachment part. Moreover, in FIG. 3A, the respective attachment parts of a first portion of the members 221 (including the members 221a, 221b) are arranged toward a first longitudinal side of the base, and the respective attachment parts of a second portion of the members 221 (including the members 221c, 221d) are arranged toward a second longitudinal side of the base opposite the first longitudinal side. In FIG. 3B, the respective attachment parts of the members 221 are arranged toward a same longitudinal end of the base. Additionally, in the arrangements of FIGS. 3C and 3D, each member 221 includes an attachment part fixed to the base, and first and second non-attachment parts rotatably moveable about the respective attachment part and arranged opposite to each other with respect to the respective attachment part.

FIG. 27B is a partially exploded view of an assembly 220. The assembly 220 includes a plurality of members 221 which are to be connected to a base 227 at respective connection locations 222. The members 221 are aligned end to end in the longitudinal directions 68 and 69, and side-by-side in the lateral directions 61 and 62. Laterally adjacent members 221 are each longitudinally offset from each other.

The connection locations 222 for members 221 are shown at the exploded portion of the assembly 220. The connection locations 222 of laterally adjacent members 221 are longitudinally staggered from each other.

Where an assembly including members also includes a base (e.g., a base layer) to which the members are attached, different forms of the base may be provided which either elastically or inelastically bend. Where an assembly includes a base that elastically bends, the base may provide a bias to the assembly towards the undeformed shape of the base. While illustrated in relation to the assembly 220 in FIG. 2A as having a substantially planar undeformed shape, bases may be provided in any desired undeformed shape to bias the assembly to that shape in the absence of the constricting force. Where an assembly includes a base that bends inelastically, the base may not provide a bias to the assembly towards a predefined shape in the absence of the constricting force. Bases which either bend elastically or inelastically may be utilised with an assembly in a jammable apparatus depending on the desired characteristics of the jammable apparatus, such as an at-rest shape of the apparatus. In some arrangements, the base layer may be configured to provide a restoring force to facilitate movement of the assembly away from the second assembly shape and toward the first assembly shape. This may occur in the absence of a constricting force which acts against and is of greater magnitude than the restoring force. Where the intermediate component is employed, the restoring force provided by the base layer, if any, may be supplementary to the returning force of the intermediate component. In such a case, the movement of the assembly between the two shapes depends on a sum of the returning and restoring forces in comparison with the constricting force.

While the assemblies 220 shown and described in relation to FIGS. 2A-D, 3A-D, and 4 include rotatably associated members that are partially connected to a base and rotatable relative to each other by bending of the base, other examples of assemblies may have rotatably associated members in other arrangements.

For example, FIG. 5 shows an assembly 320 that includes a plurality of members 321. The members 321 are arranged in six groups 331-336 of members. Each of the groups 331-336 of members have pinned connections 371-375 to other adjacent groups of members. For example, the first group 331 of the members 321 has a pinned connection 371 only with the second group 332 of members, while the second group 332 of members has a pinned connection 371 with the adjacent first group 331 of the members 321 and a pinned connection 372 with the third group 333 of the members 321. The members 321 of each group 331-336 are laterally spaced apart from each other, so that at the pinned connections of the groups to each other the members 321 of each group 331-336 are interleaved together with the members of the adjacent groups. That is to say, at each pinned connection, the group at one side of the respective pinned connection are interleaved with respect to those at the other side of the respective pinned connection.

It may also be understood that the members 321 are arranged in columns along a longitudinal direction of the assembly 320 and in rows along a lateral direction of the assembly 320. Within each row, each intermediate one of the members 321 along the longitudinal direction (i.e., those of the groups 332-335) are rotatably coupled to a respective pair of the pinned connections 371-375 (or pivot members). Furthermore, each neighbouring pair of the members 321 in each of the columns are spaced apart from each other along the lateral direction by a corresponding member 321 in a neighbouring one of the columns.

The pinned connections between at least some of the groups of members are located away from ends of the members of those groups, so that the portions of the members distal of the pinned connection define lever arms. For example, the first ends of the members 321 of the sixth group 336 of members extend peripherally of the pinned connection 377 of the sixth group 336 to the fifth group 335 to define lever arms 325. Similarly, the second ends of the members 321 of the sixth group 336 of members extending peripherally of the pinned connection 375 to define lever arms 325.

The pinned connections between others of the groups of members may be located towards the ends of the members of those groups, so that there are not lever arms defined by the members of that group of the members.

The members of each of the groups 331-336 of the members 321 of the assembly 320 are operable to pivot relative to the members of the other groups about their respective pinned connections 371-379.

As illustrated in FIG. 5, the assembly 320 is in an expanded state. This expanded state may correspond to the first assembly shape. When provided as part of a jammable apparatus, within an envelope, the exertion of a constricting force by the envelope on the assembly 320 may act against the lever arms 325 to cause a rearranging of the groups 331-336 of members relative to each other. This rearranging will compress the assembly 320 towards a more compressed state. The most compressed state of the assembly may correspond to the second assembly shape. The assembly 320 of this example has a substantially planar second assembly shape (not shown).

FIGS. 3E and 3F show two different arrangements of relatively rotatable members 321 having pinned connections between them. FIGS. 3E and 3F illustrate different arrangements of an assembly 320. In each of FIGS. 3E and 3F, details of four members 321a-d are shown along with dashed lines illustrating the locations of their respective pinned connections 371-373. In each of FIGS. 3E and 3F, laterally adjacent ones of the members 321a-d are offset from each other in the longitudinal directions 68 and 69. The offsetting of laterally adjacent members from each other is such that each of the members 321a and 321c longitudinally align with each other, as do the members 321b and 321d with each other. In each of FIGS. 3E and 3F, each of the members 311a-d have two pinned connections.

In FIG. 3E, the members 321a and 321b are each pinned away from their ends at a first pinned connection 371, and towards an end at a second pinned connection 372. The second pinned connection also passes through the members 321c and 321d away from their ends. The third pinned connection 373 passes through the members 321c and 321d towards an end of each member. Accordingly, the pinned connections 371-373 are arranged asymmetrically along each of the members 321a-d. This arrangement provides for a single lever arm 325 of each of the members 321a-d.

In FIG. 3F, the members 312a-d are each pinned by two pinned connections that are located symmetrically along the length of each of the members. For example, the members 321a and 321b are each pinned at the pinned connections 371 and 372, which are each located similar distances from away from the respective ends of each of the members 321a and 321b. Because both pinned connections of each of the members 321a-d are located away from the ends of the members, each member defines two lever arms 325, one at each end of the member. Because the pinned connections 371-373 are each located the same or substantially the same distances from the ends of the members which they pin, each of the lever arms 325 may be of the same or substantially the same length. In other examples where a member has two lever arms, the lever arms, the member may be pinned at different distances from each of its ends so that its lever arms have different lengths.

The configuration of FIG. 3E where each member of an assembly defines only one lever arm may generally be referred to as an asymmetrically pinned configuration. The configuration of FIG. 3F where each member of an assembly defines two lever arms may generally be referred to as a symmetrically pinned configuration.

FIG. 27A shows a partially exploded arrangement of an assembly 320 that includes a plurality of rotatably associated members 321. The members 321 are arranged in groups 331-337 of adjacent members in the lateral directions 61 and 62. The groups 331-337 are arranged longitudinally with each other, along the longitudinal directions 68 and 69. The members 321 of each group 331-337 are each laterally spaced apart, so that the members 321 of longitudinally adjacent groups longitudinally overlap and interleave with each other. Adjacent groups are pinned together at their overlapping portions, so the groups are able to rotate relative to each other. Two pins 322a and 322b are shown which would, when assembled, respectively connect the first group 331 with the second group 332, and second group 332 with the third group 333. Pinned locations 371-379 of the groups 331-337 are shown in FIG. 27A.

As shown in FIG. 27A, the members 321 of each group 331-337 are symmetrically pinned, as previously described in relation to FIG. 3F. Accordingly, each member may define two lever arms, one peripheral of the respective pinned locations of each member.

FIG. 6 is a side view of another arrangement of an assembly 320 with six groups 331-336 of members 321. The groups 331-336 are pinned together at respective pinned connections 371-375. In the assembly 320 of FIG. 6, the pinned connections 371-375 are each located away from respective ends of the members, so that each group 331-336 of members 321 define two lever arms 325 and 326 at respective ends of each member 321. For example, the third group 333 of members defines first lever arms 325 arranged peripherally of its pinned connection 372 with the second group 332 and defines second lever arms 326 arranged peripherally of its pinned connection 373 with the fourth group 334. In the example of FIG. 6, each member 321 of each one of the intermediate groups 332-335 along the longitudinal directions of the assembly 320 is arranged symmetrically with respect to a respective pair of the pinned connections 371-375 (or pivot members) to define opposite distal ends extending beyond the respective pair of the pinned connections 371-375 and serving as the respective lever arms 325 and 326. Moreover, each member 321 of the end groups 331, 336 along the longitudinal directions of the assembly 320 is arranged symmetrically with respect to the corresponding pinned connection 371, 375 to define opposite distal ends extending away from the corresponding pinned connection 371, 375 and serving as the respective lever arms 325 and 326. Similarly, each member 321 of the end group 336 along the longitudinal directions of the assembly 320 is arranged symmetrically with respect to the corresponding pinned connection 375 to define opposite distal ends extending away from the corresponding pinned connection 375 and serving as the respective lever arms.

With such a configuration, the relatively rotatable members 321 coupled to one of the pivot members may be understood to be interleaved with those coupled to a neighbouring one of the pivot members.

As illustrated in FIG. 2A, the assembly 220 of FIGS. 2A-D is flat when in its compressed state and the second assembly shape. This characteristic is provided by the straight or non-curved shape of each of the members 221 of the assembly 220. That is, each member may have a portion that is straight in shape.

Similarly, the assemblies 320 of FIGS. 5 and 6 are arranged so that their compressed state and second assembly shape correspond with a flat form of the assemblies. The assembly 320 illustrated in each of FIGS. 5 and 6 may also be flat in its compressed state and the second assembly shape.

Such configurations may be desirable where a jammable apparatus in the jammed state is flat. Additionally, where a jammable apparatus actuates upon the exertion of a constricting force, such configurations may be desirable where a planar or non-curved form of the jammable apparatus is wanted upon actuation.

In other examples, at least some of the members of an assembly that includes rotatably associated members may have a curved shape. The curving of the members may be such that when the jammable apparatus rearranges due to the constricting force, its shape in its compressed state is not flat. That is, each member may have a portion that is arcuate or otherwise curved in shape.

FIG. 7A shows a perspective view of another assembly 420 for a jammable apparatus. The assembly 420 has members 421. The members 421 are arranged in groups 431-439 of laterally adjacent members, and respective groups of members are longitudinally aligned and pinned to each other at pinned connections 471-478. The members of each group may be laterally spaced apart from each other between the first lateral side 17 and second lateral side 18 of the assembly, so that the members of adjacent groups are interleaved with each other. For example, at one end of the assembly 420 there is a first group 431 of the members 421 and inwardly of it is a second group 432 of the members 421. The first group 431 is rotatably connected to the second group 432 at the pinned connection 471, with the members 421 of the first group 431 interleaved with those 421 of the second group 432. The second group 432 is then rotatably connected to the third group 433 at the pinned connection 472, with the members 421 of the second group 432 interleaved with those of the third group 433.

The pinned connection of the members or groups of the members may allow an apparatus to articulate between different shapes.

Each member 421 of the assembly 420 of FIG. 7A is curved between opposite first and second ends 423, 424 thereof. The members are each curved within (or along) a plane that is oriented normal to an axis of at least an associated pinned connection. For example, the member 421a of the first group 431 curves within a plane that is normal to an axis of the pinned connection 471. As in the configuration of FIG. 7A, the pinned connections 471-478 are arranged in parallel with each other, the member 421a of the first group 431 curves within a plane that is normal to an axis of each of the pinned connections 471-478.

The pinned connections of each of the groups of the members 421 of the assembly 420 of FIG. 7A are arranged so that each member defines at least one lever arm. The members of the groups of members at each of the first end 13 and second end 14 of the assembly each define two lever arms 425 and 426, as illustrated in relation to a member 421 of the first group 431 at the first end 13 of the assembly. Each group of members away from the ends of the assembly defines a single lever arm 425, as illustrated in relation to a member 421 of the second group 432.

The assembly 420 may be operable to articulate its members 421 about their respective pinned connections. The articulation may, when located within an envelope which exerts a constricting force on the apparatus, be provided by the constricting force acting against the lever arms of the assembly. As shown in FIG. 7A, the assembly 420 is in an expanded state. This expanded shape may be a first assembly shape. The assembly 420 when used as part of a jammable apparatus may be actuated from this first apparatus shape towards a second apparatus shape.

The interleaving of the members 421 of longitudinally adjacent ones of the groups of members 431-439 of the assembly 420 is such that the lever arms may, upon articulation of the assembly, be retracted inwardly from their positions shown in FIG. 7A. In the expanded state shown in FIG. 7A, the assembly 420 has voids 480, each of which is located at a respective internal space cooperatively defined by an adjacent pair of the members in each intermediate group and a corresponding member in an adjacent group pinned to the respective intermediate group. The interleaving of the members 421 in such a configuration is such that all but the second lever arms 426 of the end-most groups 431 and 432 are able to be retracted so that they lie entirely within the respective voids 480.

FIGS. 7B-D are side views of the assembly 420 of FIG. 7A, in three different assembly shapes. As seen in FIG. 7B, the assembly 420 is in a similar expanded state (or condition) as is illustrated in FIG. 7A. In FIG. 7B the curved shape of the members 421 of the assembly are shown in profile.

In FIG. 7C the assembly 420 has been partially articulated by the rotation of the members 421 relative to each other about their pinned connections 471-478. The articulation retracts the lever arms 425 and 426 to partially lie in-line with the remainder of the members of the assembly. As seen in FIG. 7C, the lever arms 425 have each been partially retracted within the respective voids 480 of the assembly 420.

FIG. 7D illustrates a further articulated condition of the assembly 420 in which the lever arms 425 have each been fully or substantially retracted within the voids 480 of the assembly 420. In FIG. 7D the assembly 420 is in a compressed state relative to the state shown in FIGS. 7A, 7B, or 7C. The arrangement of the assembly 420 of FIG. 7D may represent a second assembly shape, to which the assembly may be articulated by the constricting force of a conformable envelope.

As seen in FIG. 7D, in the second assembly shape the contiguity of the members 421 of the assembly 420 at both the first side 11 and second side 12 is increased relative to the first assembly shape illustrated in FIG. 7A.

Although in the second assembly shape of the assembly 420 in FIG. 7D is relatively more curved between its first end 13 and second end 14 than in the first assembly shape shown in FIG. 7A, in the second assembly shape of FIG. 7D at least a surface at the first side 11 of the assembly is relatively more continuous than in the first assembly shape as illustrated in FIG. 7A. In FIG. 7A the curved members and the lever arms 225 cause the surface at the first side 11 not be relatively non-continuous.

In addition, in the second assembly shape of FIG. 7D the second side 12 of the assembly 420, being the side opposite to the first side 11, is relatively more continuous than in the first assembly shape of FIG. 7A, where the curved members 421 cause a surface of the assembly at the second side 12 to be relatively non-continuous.

As shown in FIG. 7D, the surface of the assembly 420 at the first side 11 is substantially continuous, having the longitudinally overlapping extents of each member 421 between the first end 13 and second end 14 of the assembly lie contiguously with each other in a direction between the first side 11 and second side 12 of the assembly 420. As shown in FIG. 7D a surface of the assembly 420 at the second side 12 of the assembly 420 is also relatively continuous.

The jamming operation and the resultant increase in stiffness of a jammable apparatus by a constricting force applied by an envelope may be greatest when the assembly within the jammable apparatus has a relatively continuous surface. For example, when the assembly 420 is incorporated in a jammable apparatus, the jamming interactions of the jammable apparatus may be at their greatest when the assembly 420 has rearranged to the second assembly shape as shown in FIG. 7D, where the retracted lever arms all lie within the extents of their adjacent members so the surfaces of the assembly 420 at both the first side 11 and second side 12 are relatively continuous. When the surfaces of an assembly at both a first side and opposed second side are relatively continuous, surface interactions between the assembly and adjacent components of the jammable apparatus may be increased, allowing for increased frictional and kinetic interactions and maximised stiffness of the jammable apparatus for a given pressure difference between the inside and outside of its envelope.

While the assembly 420 of FIG. 7A has nine groups 431-439 of members which are successively pinned together, the number of laterally adjacent members within a group of members and the number of successively pinned together groups of a given apparatus may be selected according to the desired properties, performances or characteristics of the jammable apparatus which is to include the assembly. Similarly, as shown in FIG. 7A the members 421 of the assembly 420 are all of the same size and shape. In other arrangements, an assembly may include members of different sizes and/or shapes. The members of different groups or the same group may have different lengths. For example, a first group of laterally adjacent members may have a first length and be pinned to a second group of laterally adjacent members that have a different second length. The members of different groups or the same group may have different curvatures. In other examples, the curvature of different members or groups of members may be different within a given assembly. The properties of a jammable apparatus which may be varied by changing the number of members in a laterally adjacent group of members, the number of groups in an assembly, or the size or shape of the members may include a jammed shape that the jammable apparatus assumes. The variable properties may additionally or alternatively include a non-jammed shape of the apparatus. The variable properties may additionally or alternatively include the nature of any articulation of the jammable apparatus between two non-jammed shapes.

It can be seen that in FIGS. 5 to 7, the rotation members coupled to an intermediate one and a previous one of the pivot members are interleaved with those coupled to the intermediate one and a next one of the pivot members. For example, with reference to FIG. 7A, the members 433 coupled to the pinned connection 473 (intermediate one) and the pinned connection 472 (previous one) are interleaved with those 434 coupled to the pinned connection 473 (intermediate one) and the pinned connection 474 (next one). With the components 431-439 and 471-478 in this arrangement, the assembly assumes a rotatable, bendable mesh-like configuration advantageous in terms of, for example, durability and strength. Where jammed, such a structure can provide improve strength and flexibility, for example.

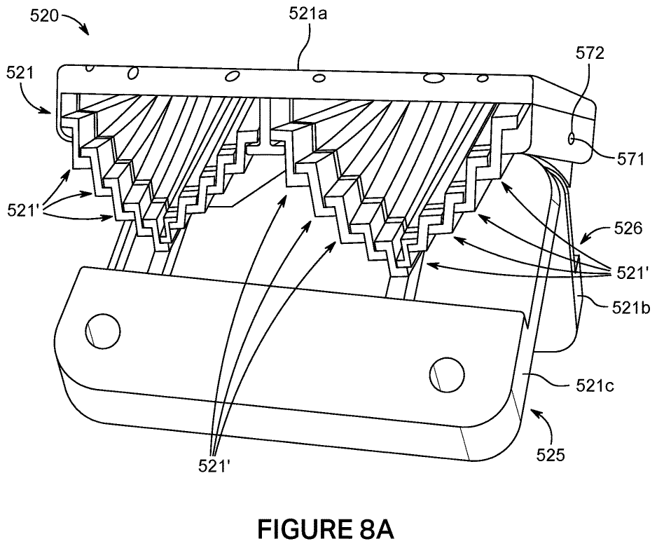

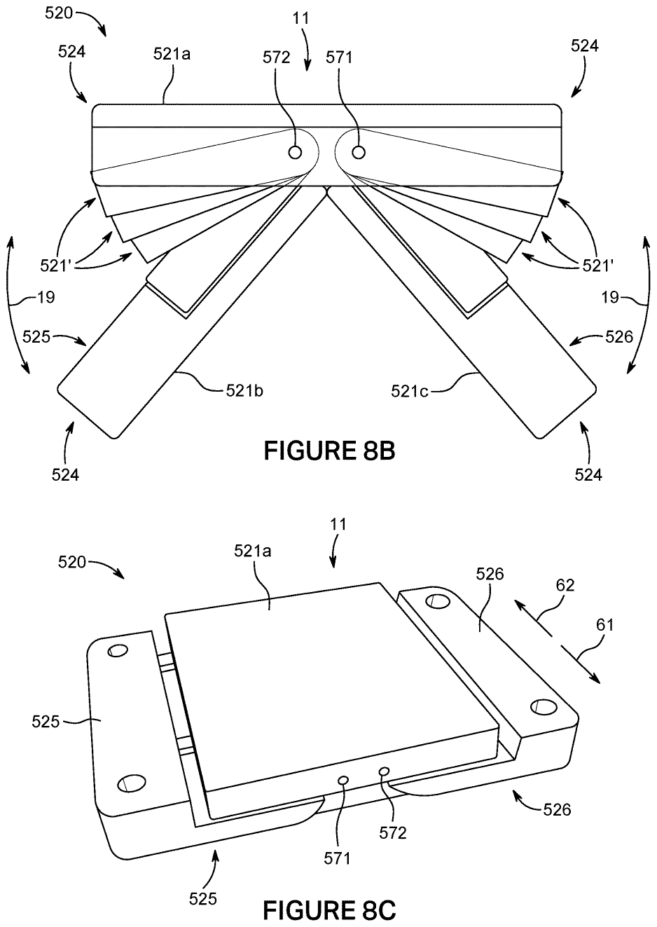

FIGS. 8A-C show another assembly 520 for use as part of a jammable apparatus. The assembly 520 has members 521 which are rotatably associated with each other. The direction of relative rotational movement of the members 521 relative to each other is illustrated at the arrows 19 in FIG. 8B. The members 521 include outer members 521a, 521b, and 521c, and internal members 521′. The internal members 521′ are located respectively between the outer member 521a and the outer member 521b, and between the outer member 521a and the outer member 521c. The internal members 521′ are arranged adjacent to each other in the lateral directions 61 and 62. The outer members 521a and 521b and the internal members 521′ therebetween are pinned together at a first pinned connection 571. The outer members 521a and 521c and the internal members 521′ therebetween are pinned together at a second pinned connection 572. The members 521′ between the outer members 521a and 521b may form a first group, and those between the outer members 521a and 521c may form a second group.

Some of the internal members 521′ are rotatable about their pinned connection up to a limit provided by interaction of the member 521′ with either an adjacent member or members 521′ or where adjacent an outer member 521a, 521b, or 521c. This is illustrated in FIG. 8A and FIG. 8B in relation to the configuration of the internal members 521′. The internal members 521′ adjacent the outer members 521b and 521c are limited in their rotational movement by interaction with outer members 521b or 521c. Each of the internal members 521′ therebetween are also limited in their degree of rotation by interference with laterally adjacent ones of the members 521′. That is, the outer members 521a, 521b are configured to restrict rotation of each internal member 521′ in the first group about the respective pinned connection 571. The outer members 521a, 521c are configured to restrict rotation of each internal member 521′ in the second group about the respective pinned connection 572.

The internal members 521′ each have a stepped structure which overlap with adjacent ones of the outer members 521a-c and internal members 521′ to provide limits to the degree of rotation of each component relative to adjacent components.

By this arrangement, the outer members 521b and 521c may be rotatable relative to each other and relative to the other outer member 521a, but only up to a predetermined restriction angle (or angle of limitation). As seen in FIG. 8A, the outer members 521b and 521c have been rotated away from the outer member 521a and towards each other to their restriction angle determined by the interference of the members 521 with each other.

Respective portions of the outer members 521b and 521c distal from the other outer member 521a may define the lever arms 525 and 526 of the assembly. In the first assembly shape shown in FIG. 8A, the lever arms 525 and 526 are extended away from the other outer member 521a.

FIG. 8B shows a side view of the assembly 520 in an expanded state. The expanded state of the assembly may correspond to a first assembly shape. As seen in FIG. 8B each of the members 521 of the assembly 520 has been rotated relative to laterally adjacent members up to their respective restriction angles.

FIG. 8C shows a perspective view of the assembly 520 in a compressed state. When used in a jammable apparatus, the assembly 520 may be articulated away from the expanded state to or towards the shape shown in FIG. 8C upon the exertion of a constricting force by an envelope of the jammable apparatus within which the assembly is located.

In the second assembly shape seen in FIG. 8C, the contiguity of members 521 of the assembly with each other is increased compared to in the first assembly shape seen in FIG. 8A or 8B.

As seen in FIG. 8C, the surface of the assembly 520 at the first side 11 in the compressed state of the assembly is relatively more continuous than in the expanded state of the assembly 520 seen in FIGS. 8A and 8B.

The lever arms 525 and 526 in the compressed state, which corresponds to the second assembly shape as shown in FIG. 8C, are rotated towards the outer member 521a relative to the expanded state corresponding to the first assembly shape as shown in FIGS. 8A and 8B.

Where an assembly 520 is incorporated within an envelope of a jammable apparatus and the assembly is in the first assembly shape, an exertion of the constricting force by the envelope may act to pivot the lever arms 524 and 526 of the outer members 521b and 521c towards the other outer member 521a, to compress the assembly towards the second assembly shape illustrated in FIG. 8C.

Thus, each of the internal members 521′ is rotatably coupled at a proximal end thereof to one of the pinned connections 571, 572. For each of the pinned connections 571, 572, each laterally adjacent pair of the corresponding internal members 521′ forms a respective angle in the position shown in FIGS. 8A and 8B. Furthermore, the internal members 521′ of one of the pinned connections 571, 572 are arranged symmetrically with respect to the internal members 521′ of the other one of the pinned connections 571, 572.

The maximum amount of rotation of each of the outer members 521a and 521c (i.e., the restriction angle) is illustrated in FIG. 8B as being about 45 degrees. Together, the outer members 521a and 521c cooperate to provide about 90 degrees of relative articulation between their compressed and expanded states, as shown in FIGS. 8B and 8C respectively. In a jammable apparatus which includes the assembly 520, this may provide for a maximum articulation across the jammable apparatus of about 90 degrees.

The amount of allowable rotation between the outer member 521a and either one of the two outer members 521b, 521c may be controlled through selection (or configuration) of the number of adjacent internal members 521′ between the outer member 521a and said outer member 521b, 521c and/or the restriction angle each member provides. For example, the limit of relative rotation between adjacent ones of the internal members 521′ may be varied to adjust the allowable rotation between the outer member 521a and said outer member 521b, 521c.

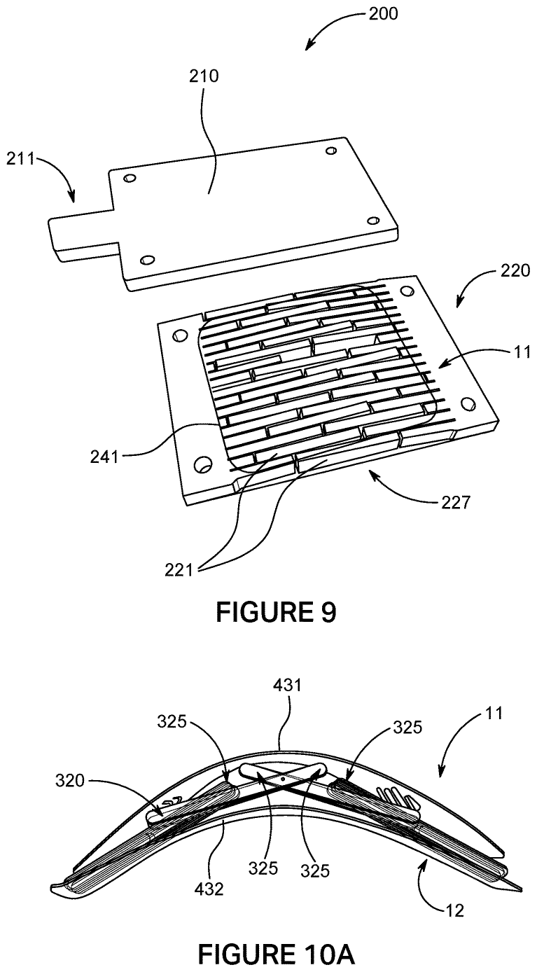

FIG. 9 illustrates components of a jammable apparatus 200. The jammable apparatus 200 includes an assembly 220 that includes relatively rotatable members 221. The assembly 220 is shown in the configuration of the assembly 220 of FIGS. 2A-D, where each of the members 221 are partially connected to a base 227. An envelope 210 is shown, within which the assembly 220 is to be located. The envelope 210 has an opening 211 which may be connectable to a vacuum pressure source.

An intermediate component 241 (also referred to herein as “intermediate layer”) is also shown in FIG. 9. The intermediate component 241 is to be located in use between the first side 11 of the assembly 220 and the envelope 210.

As seen in FIG. 9, the intermediate component 241 is in the form of a layer and extends across at least part of the first side 11 of the assembly 220. The intermediate component 241 may be provided to reduce or prevent catching of the projecting lever arms by local deformation in the envelope. Such an intermediate component between an assembly and the envelope may thus act to facilitate the articulation of the assembly.

In the illustrated arrangement of FIG. 9, the jammable apparatus 200 includes only a first intermediate component 241 at the first side 11 of the assembly 220. In other examples, a jammable apparatus may include more than one intermediate component, and the intermediate components may be arranged at more than one side of an assembly of the jammable apparatus. In some examples, the apparatus may include a pair of intermediate components sandwiching an assembly therebetween.

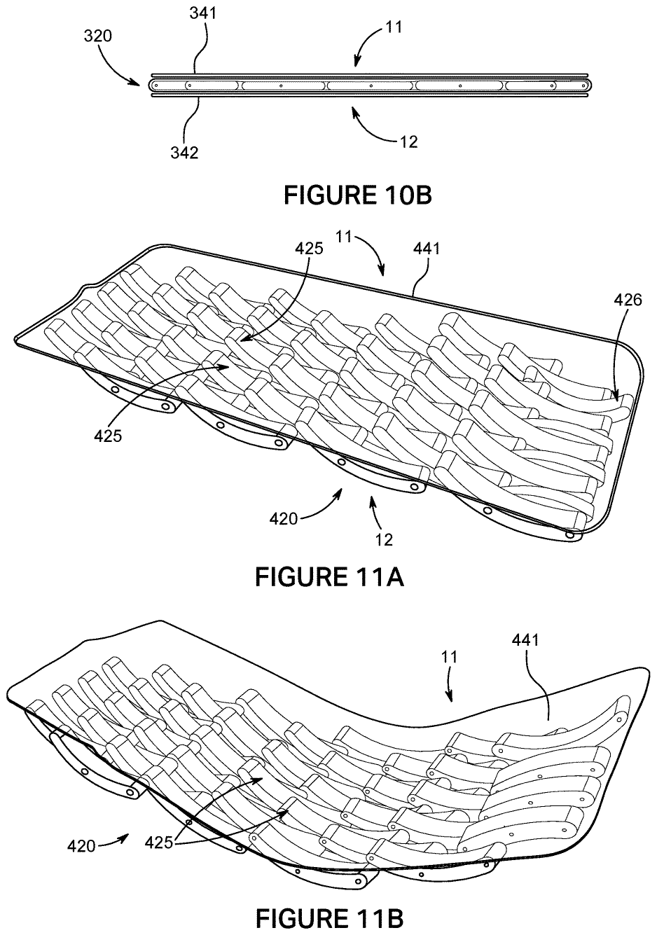

FIGS. 10A and 10B show side views of an assembly 320 in the form of the assembly 320 previously described in relation to FIG. 6. In FIG. 10A, the assembly 320 is in a first assembly shape, and in FIG. 10B the assembly is in a second assembly shape.

A first intermediate component 341 is provided at a first side 11 of the assembly 320. A second intermediate component 342 is also provided at a second side 12 of the assembly 320. The second side 12 opposes the first side 11.

In FIG. 10A the assembly 320 is articulated to the first assembly shape. The first intermediate component 341 and the second intermediate component 342 are shown to conform to the first side 11 and the second side 12 of the assembly 320, respectively. In the first assembly shape shown in FIG. 10A some of the lever arms 325 of the assembly are displaced away from the remainder of the assembly 320.

In FIG. 10B the assembly 320 is articulated to the second assembly shape. In the second assembly shape the lever arms 325 of the assembly 320 shown to be displaced in FIG. 10A are retracted towards the remainder of the assembly 320 relative to their arrangement shown in the first assembly shape shown in FIG. 10A. As seen in FIG. 10B the lever arms 325 are fully retracted within the assembly. The second assembly shape corresponds to a relatively compressed state compared to the first assembly shape. As described in relation to FIG. 6, the assembly 320 of FIGS. 10A and 10B is configured to be flat in the second assembly shape.

As can be understood from a comparison between the second assembly shape in FIG. 10A and the first assembly shape in FIG. 10B, a distance between the first intermediate component 341 and the second intermediate component 342 changes. For example, as seen between FIGS. 10A and 10B a distance of the first intermediate component 341 and second intermediate component 342 at a middle of the assembly 320 changes between the first assembly shape and the second assembly shape. The assembly 320 may be said to be compressed by the first intermediate component and the second intermediate component therebetween during the articulation from the first assembly shape and the second assembly shape.

The first and second intermediate components 341 and 342 employ a sheet-like form and are shown to have a bent state in FIG. 10A and an unbent state in FIG. 10B.

In other examples, the intermediate components 341 and 342 may be configured to resiliently assume the respective shapes shown in FIG. 10A in the absence of a sufficient constricting force acting by the envelope against the intermediate components 341, 342.

In use in a jammable apparatus, an intermediate component may be provided between one or more portions of the assembly and the envelope. For example, an intermediate component may be provided between a side or part of a side of the assembly and the envelope. An example of this is illustrated in the configuration of FIG. 9. In other examples, an intermediate component may be provided between each one of selected sides of the assembly and the envelope. In still other examples, more than one intermediate component may be provided between one or more sides of the assembly and the envelope. For example, where the arrangement of FIGS. 10A and 10B are provided within an envelope, the first intermediate component 441 may be located between the first side 11 of the assembly and the envelope, and the second intermediate component 442 may be located between the second side 12 of the assembly and the envelope. In at least some examples, an intermediate component or components may be provided between the envelope and at least one portion of the assembly where the lever arms of the assembly project and retract as the assembly is articulated.

FIG. 11A shows another view of an assembly 420 as has been described in relation to FIGS. 7A-D. In the first assembly shape as illustrated in FIG. 11A, the lever arms 425 and 426 of the assembly 420 project from the first side 11 of the assembly in a direction away from and opposite to the second side 12 of the assembly. A first intermediate component 441 is shown in FIG. 11A, located at the first side 11 of the assembly.

FIG. 11B shows the assembly 420 and the first intermediate component 441 of FIG. 11A in a scenario where a force has been locally applied to the intermediate component 441 emulating locally the effect of a constricting force acting on the assembly and the first intermediate component, causing the assembly to articulate. As seen in FIG. 11B, around where pressure has been applied the lever arms 426 have been urged to retract towards the remainder of the assembly. The retraction of the lever arms 426 has caused a rotation of some of the members 421 of the assembly 420 about their respective pinned connections. The rotation of the members 421 has caused an articulation of the assembly 420, so that the assembly is in a partially curved and relatively more compressed shape. This may be a shape between the first assembly shape illustrated in FIG. 10A, and a second assembly shape of the assembly 420 such is shown and described in relation to FIG. 7D.

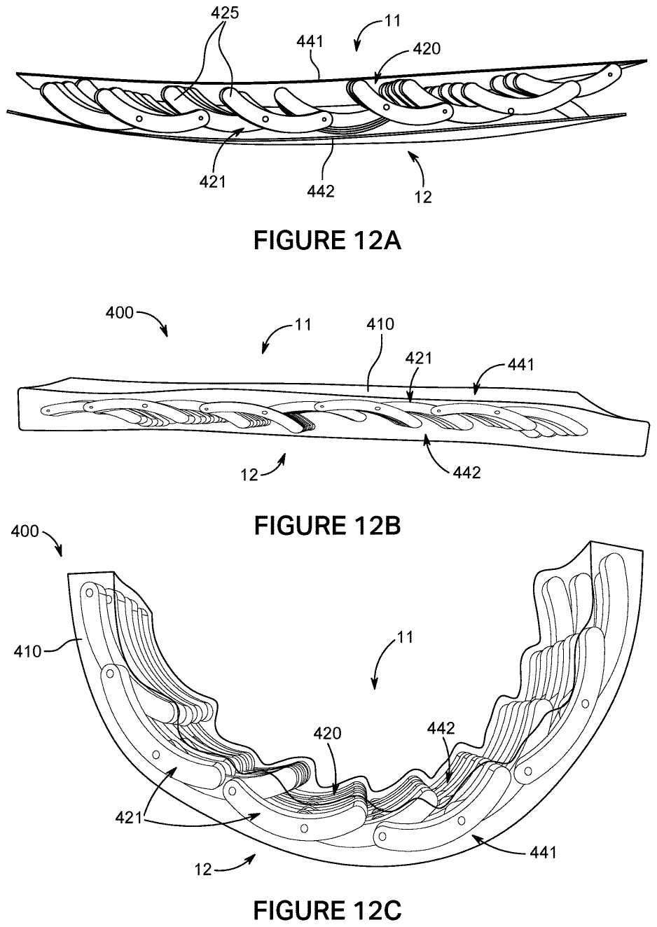

FIG. 12A is a side view of the assembly 420 having curved members 421. A first intermediate component 441 and a second intermediate component 442 are provided respectively at the opposite first side 11 and second side 12 of the assembly 420. The first and second intermediate components 441 and 442 shown in FIG. 12A are resiliently deformable away from a planar shape (illustrated in FIG. 11A), so that, when the constricting force is removed or no longer sufficient, the intermediate components 441 and 442 exert a returning force on the assembly to bias the members 421 back to a planar shape (e.g., the first assembly shape). When incorporated in a jammable apparatus, the planarly biased intermediate components may bias the jammable apparatus towards a planar form. As previously described, in other examples an intermediate component or components may be provided with any other desired non-planar undeformed shape.

FIG. 12B is a side view of a jammable apparatus 400, which has an envelope 410 and the assembly 420 and the first and second intermediate components 441 and 442 of FIG. 12A provided within the envelope 410. As seen in FIG. 12B jammable apparatus 400 is in an unjammed state corresponding to the first apparatus shape, in the absence of a pressure difference to provide a constricting force. In the first apparatus shape the jammable apparatus has an at least substantially non-curved or planar form.

Upon the exertion of a constricting force which overcomes (e.g., is greater than) any biasing force (i.e., the returning force) of the intermediate components and any frictional resistance, the jammable apparatus 400 may be transformed from the first apparatus shape towards a second apparatus shape. FIG. 12C shows the jammable apparatus 400 of FIG. 12B where a vacuum pressure has been applied within the envelope 410. In use, the envelope 410 constricts, under the influence of the vacuum pressure, to exert on the contents thereof a constricting force sufficiently large (i.e., greater than the returning force) to overcome the returning force of the intermediate components to cause the assembly to articulate toward the second assembly shape and consequently the jammable apparatus 400 toward the second apparatus shape.

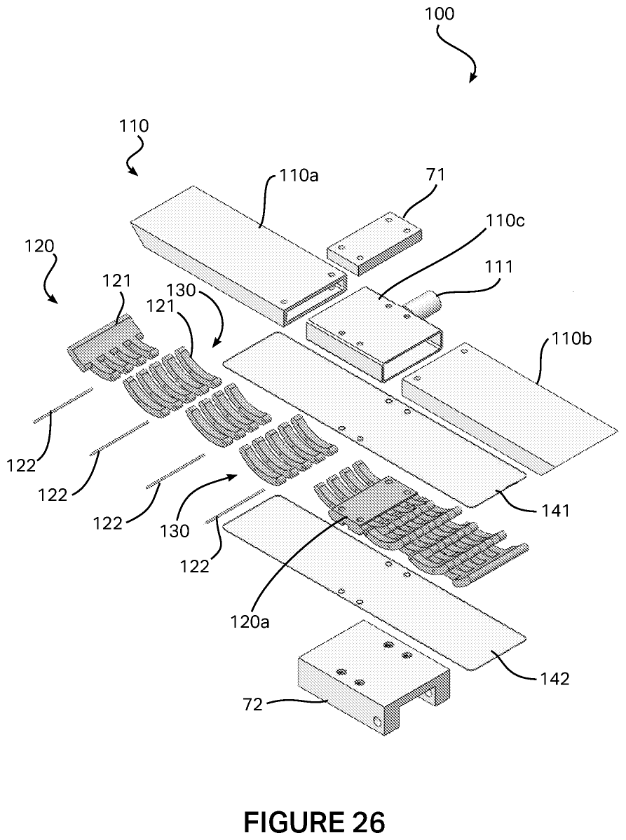

FIG. 26 is an exploded view of an illustration of a jammable apparatus 100 of the configuration of FIGS. 1A and 1B. The jammable apparatus 100 has an assembly 120 and an envelope 110. The envelope 110 includes a first part 110a, second part 110b, and third part 110c which are connectable together to define the envelope 110. To define the envelope 110, respective ends of the first part 110a and second part 110b are inserted over ends of the third part 110c. The third part 110c has an opening 111 which may be connectable to a vacuum pressure source to operate the jammable apparatus 100. The assembly 120 has ten groups 130 of members 121. The groups 130 each have pinned connections between them, and four pins 122 are shown in FIG. 26.

On two sides of the assembly 120 a first intermediate layer 141 and second intermediate layer 142 are respectively provided. A first external component 71 and second external component 72 are provided on either side of the other components of the jammable apparatus 100. Each component of the jammable apparatus between the first external component 71 and second external component 72 have holes formed in them, which align with holes in the external components 71 and 72. For example, the assembly 120 includes a central portion 120a with holes formed through it. When the components of FIG. 26 are assembled, they may be secured together by fasteners extending through the aligned holes of the components.

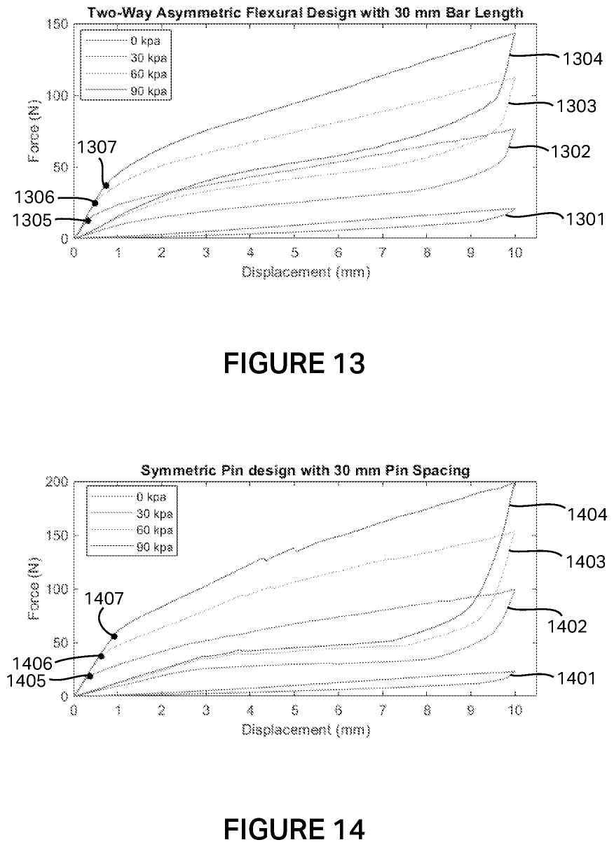

FIGS. 13-19 illustrate various experimental characteristics of different jammable apparatus configurations and test conditions.

FIG. 13 is a force-displacement graph showing the experimental characteristics of a jammable apparatus. The jammable apparatus tested is a flexural arrangement, where the assembly of the jammable apparatus has members partially attached to a base. The assembly of the tested jammable apparatus has its members arranged as illustrated in and described in relation to FIG. 4, where the assembly is able to be rearranged (e.g., where the assembly is user-operable to be rearranged) to two different expanded shapes. This arrangement may be referred to as a two-way asymmetric flexural configuration of a jammable apparatus. The members of the jammable apparatus are each of uniform lengths of 30 mm. The jammable apparatus is biased towards the second apparatus shape, for example by a biasing provided by one or more intermediate components.

Where the envelope of a jammable apparatus elastically deforms, the envelope may additionally or alternatively be utilised to provide a bias towards one or the other of the first apparatus shape or second apparatus shape. For example, the jammable apparatus tested in FIG. 13 may have an envelope which is elastically deformable away from the second assembly shape, so that it provides a biasing of the assembly to return to or towards the second assembly shape when it is rearranged therefrom.

FIG. 13 plots the tested force-displacement characteristics of this jammable apparatus at four different pressure levels. The plots each show the force-displacement characteristics of a jammable apparatus from its jammed condition and second apparatus shape, as it experiences an increasing resistive force which urges the apparatus to articulate towards the first apparatus shape. The apparatus reaches the first apparatus shape at a displacement of 10 mm. After being operated to the first apparatus shape, and under continued application of the vacuum pressure, the resistive force is reduced to zero and the plots show the resulting displacement characteristics in each arrangement.

The first plot 1301 shows the force-displacement characteristics of the jammable apparatus between no pressure difference between the inside and outside of the envelope of the apparatus. The second plot 1302 shows the characteristics of the jammable apparatus at a 30 kPa reduced pressure within the envelope. The third plot 1303 shows the characteristics of the jammable apparatus at a 60 kPa reduced pressure within the envelope. And finally, the fourth plot 1304 shows the characteristics of the jammable apparatus at a 90 kPa reduced pressure within the envelope.

When a pressure difference is applied in each of plots 1301, 1302, and 1303, the jammable apparatus demonstrates defined yield points, respectively points 1305, 1306, and 1307. Without the application of a pressure difference between the inside and outside of the envelope in plot 1304, the apparatus does not exhibit a yield point. The force at which the jammable apparatus yields from the second apparatus shape increases as the applied pressure difference between the inside and outside of the envelope increases. This characteristic may be utilised to provide variable stiffness to a jammable apparatus. Because the pressure difference applied across the envelope may be rapidly changed, the variation in stiffness may be able to be provided rapidly.

In each of the plots 1302-1304, the resistive force required to continue rearranging the apparatus towards the first apparatus shape continues to increase after reaching their respective yield points. In the first plot 1301, which does not demonstrate a yield point, the resistive force minimally increases as the apparatus is displaced, in order to overcome the biasing of the apparatus to the second apparatus shape.

In each of plots 1301-1304, once the maximum displacement is achieved, for example to the first apparatus shape, and the resistive force is reduced, the jammable apparatus returns the displacement and articulates back to the second apparatus shape.

This characteristic may be provided where the forces urging the rearranging of the apparatus back to the second apparatus shape due to the constricting force are not exceeded by the jamming interactions of the members of the assembly of the jammable apparatus with adjacent components of the jammable apparatus.

The ability of a jammable apparatus to self-return displacement away from its actuated condition may increase the range of functions for which a jammable apparatus may be implemented. For example, where a jammable apparatus is used to provide a gripping actuation upon the exertion of a constricting force, such as is for example illustrated in FIG. 1B, a self-returning of the jammable apparatus to the first apparatus shape, as illustrated in FIG. 1A, may allow the jammable apparatus to be used to repeatedly provide grasping and releasing actuations. Such repeated grasping and releasing actuations may however be provided with only a single control input, being the vacuum pressure which defines or determines the constricting force.

FIG. 14 plots the tested force-displacement characteristics of another arrangement of a jammable apparatus at four different pressure differences between an inside and outside of the envelope of the jammable apparatus. The jammable apparatus tested in FIG. 14 has an assembly with symmetrically pinned members, being groups of laterally adjacent members. The symmetrically pinned members define one lever arm at each end of each member. The spacing between the pins of each of the members with two pins is 30 mm.

As in FIG. 13, in FIG. 14 four plots 1401, 1402, 1403, and 1404 show the force-displacement characteristics of the apparatus at respectively 0 kPa, 30 kPa, 60 kPa, and 90 kPa of reduced pressure within the envelope relative to outside of it. The yield points of the jammed apparatus of plots 1402, 1403, and 1404 are respectively illustrated at points 1405, 1406, and 1407.

The plots 1401-1404 show broadly similar characteristics to the plots 1301-1304 of FIG. 13, where the plots 1402-1404 have pronounced and increasing yield points, and upon the reduction of the resistive force the return their displacement back towards their initial second apparatus shapes. In the test of FIG. 14 however, relatively greater yield points are exhibited by its tested jammable apparatus in each of plots 1402-1404 than are exhibited by the tested jammable apparatus of the corresponding plots 1302-1304 of FIG. 13.

In the plots 1402-1404 of FIG. 14 the rate of return of the tested jammable apparatus from its displaced position to its undisplaced position (or non-displaced position) when the constricting force is reduced and ultimately removed is also slower than in the corresponding test conditions of plots 1402-1404 of FIG. 13.

The return of the apparatus from its displaced position to its undisplaced position are shown on the lower side of each plot from the peak of the plots back to the 0-0 point. The comparative rates of return to the undisplaced position are shown by the respective displacements of each plot for a given reduced constricting force value. For example, where the constricting force is reduced to about 50 N, the jammable apparatus of plot 1402 has returned to a displacement of about 9.5 mm, while the jammable apparatuses of plots 1403 and 1404 have returned to a displacement of about 7 mm.

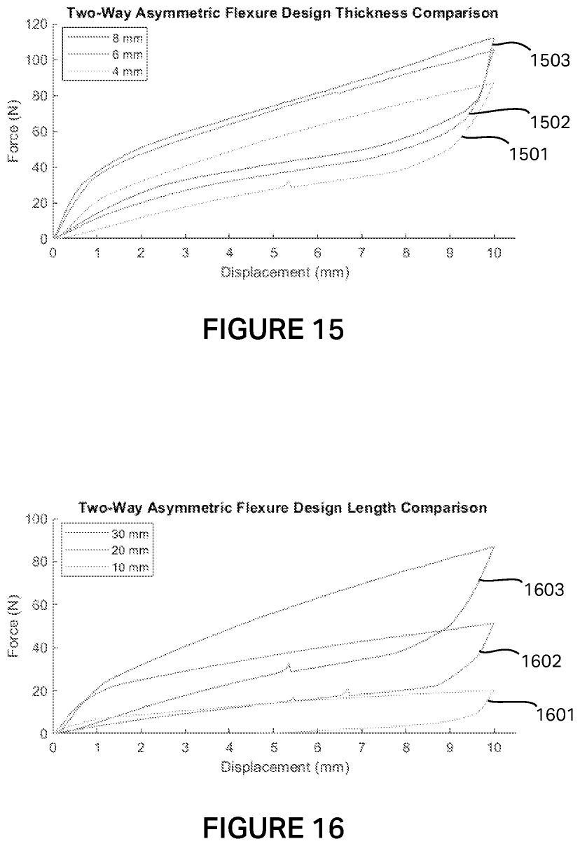

FIG. 15 plots the tested force-displacement characteristics of another arrangement of a two-way asymmetric flex jammable apparatus in three different configurations, having members of three different thicknesses relative to the base of the assembly.

The first plot 1501 shows the test results with 4 mm thick members, the second plot 1502 shows the test results with 6 mm thick members, and the third plot 1503 shows the test results with 8 mm thick members. The plots 1501-1503 illustrate an increase in the yield point between the arrangement of the first plot 1501, then a similar yield point between the arrangements of the second plot 1502 and third plot 1503. The plots however illustrate a positive relationship between the resistive force required to operate the jammable apparatus to maximum displacement and the thickness of the members of the tested jammable apparatus.

FIG. 16 plots the tested force-displacement characteristics of another two-way asymmetric flex jammable apparatus having and assembly with members partially connected to a base. In FIG. 16 the plots 1601, 1602, and 1603 respectively show the test results with 10 mm, 20 mm, and 30 mm member lengths.

Plots 1601-1603 illustrate a positive relationship between the length of the members in the assembly of the jammable apparatus and the resistive force required to displace the assembly. Plots 1601-1603 also illustrate a positive relationship between the length of the members in the assembly of the jammable apparatus and the ability of the jammable apparatus to return the deformation upon the reduction of the resistive force, and its rate of return as the constricting force decreases. In plot 1601 with 10 mm members, the displacement was only partially returned upon the removal of the resistive force. In each of plots 1602 and 1603 however, the entirety or a substantial entirety of the displacement is returned upon the removal of the resistive force. Furthermore, the 30 mm members of plot 1603 exhibit a returning of the displacement relatively more readily than do the 20 mm members of plot 1302.

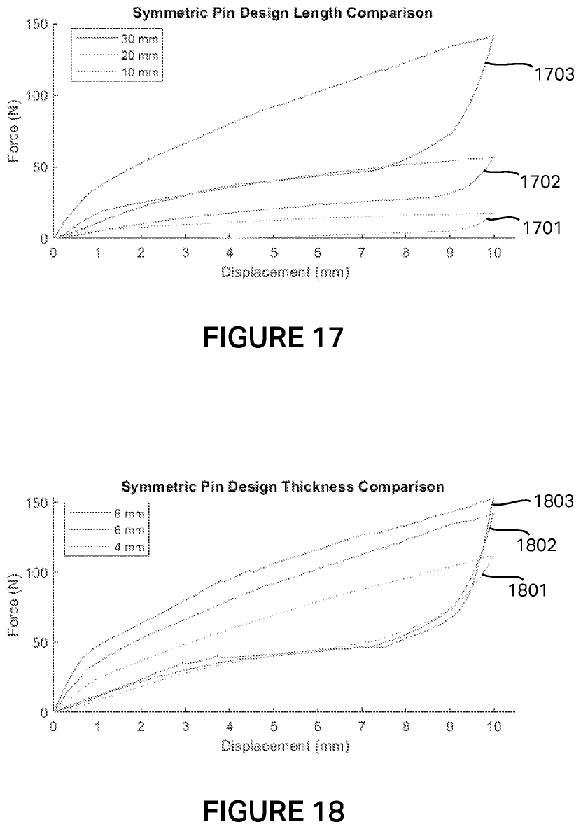

FIG. 17 plots the tested force-displacement characteristics of another jammable apparatus with an assembly having symmetrically pinned members, where each member defines two lever arms. The plots 1701, 1702, and 1703 show the tested characteristics of this configuration of the apparatus with respectively 10 mm, 20 mm, and 30 mm long members. Plots 1701-1703 demonstrate a positive relationship between the length of the members in the assembly of the jammable apparatus and both a) the yield point and b) the required resistive force for a given deformation subsequent to yielding. The plots 1701-1703 also demonstrate that the rate of return of the deformation increases as the tested member length increases.

FIG. 18 plots the tested force-displacement characteristics of another jammable apparatus having symmetrically pinned members of its assembly. The plots 1801, 1802, and 1803 of FIG. 18 show tested configurations of this jammable apparatus with respectively 4 mm, 6 mm, and 8 mm member thicknesses. The plots 1801-1803 demonstrate an increase in the yield point of the apparatus with an increase in the thickness of the members. They also demonstrate an increase in the amount of resistive force required to continue to rearrange the jammable apparatus past the yield point as the thickness of the members increases. The plots 1801-1803 do not however demonstrate a significant effect of the thickness of the members upon the ability for the jammable apparatus to remove displacement once the resistive force is removed, or the rate of return of the displacement when the resistive force is removed.

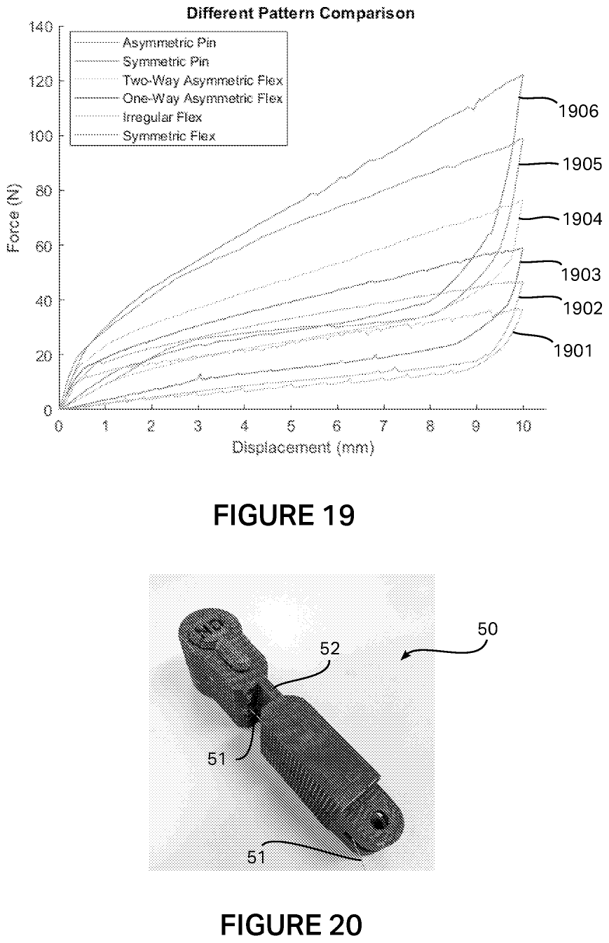

FIG. 19 plots the tested force-displacement characteristics of six different assembly configurations of a jammable apparatus.

The first plot 1901 shows the tested characteristics of a jammable apparatus with an assembly having members partially attached to a base and arranged as illustrated in FIG. 3C.

The second plot 1902 shows the tested characteristics of a jammable apparatus with an assembly having members partially attached to a base and arranged as illustrated in FIG. 3D.

The third plot 1903 shows the tested characteristics of a jammable apparatus with an assembly having members partially attached to a base and arranged as illustrated in FIG. 3B.

The fourth plot 1904 shows the tested characteristics of a jammable apparatus with an assembly having members partially attached to a base and arranged as illustrated in FIG. 3A.

The fifth plot 1905 shows the tested characteristics of a jammable apparatus with an assembly having asymmetrically pinned members, for example as illustrated and described in relation to FIG. 3E.

The sixth plot 1906 shows the tested characteristics of a jammable apparatus with an assembly having symmetrically pinned members, for example as illustrated and described in relation to FIG. 3F.

The plots 1901-1906 generally show an increased yield strength as the number of the plot increases. Similarly, the plots show an increased resistive force required to continue to deform the jammable apparatus past its yield point as the number of the plot increases. Finally, the plots also show that the deformation force at maximum displacement also increases with each successive one of the plots 1901-1906.

As a relatively increased resistive force required to deform a jammable apparatus from its jammed condition and second apparatus shape indicates a relatively increased stiffness of the jammable apparatus, the plots of FIGS. 13-19 illustrate design parameters of a jammable apparatus which may be selected to provide one or more of a desired yield point, desired stiffness characteristics, and desired returning properties in use.

Having regard to the foregoing features and functionality of jammable apparatuses, various examples of applications of the jammable apparatuses will now be described.

FIG. 20 illustrates a single degree of freedom tendon-driven finger actuator 50 according to the prior art. The actuator has a bending joint 52 which provides a single degree of freedom. The actuator is operable to bend at the bending joint 52 by the application of tension to the tendon 51.

A jammable apparatus may be utilised in place of the bending joint 52 of the actuator 50 to provide a variable stiffness joint. Where the jammable apparatus is actuatable when it is jammed, it may also provide for an actuation of the actuator.

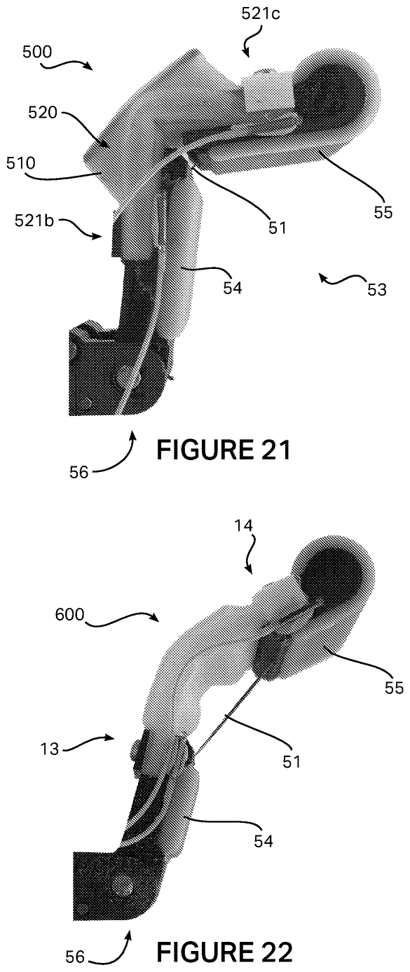

FIG. 21 shows a tendon-driven finger actuator 53. The actuator 53 has a first portion 54 and a second portion 55 which are to actuate relative to each other. A jammable apparatus 500 is connected to each of the first portion 54 and second portion 55. The jammable apparatus 500 includes an assembly 520 of the configuration of FIGS. 8A-C, and the outer member 521b and 521c are respectively attached to the first portion 54 and second portion 55 of the actuator 53. The assembly 520 is provided within an envelope 510. The actuator has a first degree of freedom about the first pivot 56, and a second degree of freedom provided by the jammable apparatus 500. The operation of the tendon 51 is able to actuate the second portion 55 to rotate about the first portion 54 by articulation of the jammable apparatus 500. The operation of the tendon 51 is also able to actuate the first and second portions 54 and 55 together about the pivot 56. The pivot 56 may be biased in one rotational direction, so that the tendon 51 may act to rotate the first portion 54 and second portion 55 about the pivot 56 by a shortening of the tendon 51, but the rotation may be returned by the bias upon a subsequent lengthening of the tendon 51.

Because the stiffness of the jammable apparatus 500 may be varied by the application of different vacuum pressures within it, the stiffness of the jammable apparatus 500 as the second degree of freedom of the actuator 53 may be able increased or decreased either above or below the stiffness at the pivot 56. Accordingly, in combination with the vacuum pressure supplied to the jammable apparatus 500, the operation of the single tendon 51 may be able to separately control the two degrees of freedom of the actuator 53.

In addition, as the jammable apparatus 500 may actuate from the first apparatus shape to the second apparatus shape, where the jammable apparatus 500 is initially not in its second shape, upon the exertion of the constricting force the jammable apparatus may provide an actuation of the second portion 55 of the actuator 53 relative to the first portion 54 of the actuator.

FIG. 22 shows another tendon-driven finger actuator 53, with a different jammable apparatus 600 connected between its first portion 54 and second portion 55 to provide at least one degree of freedom therebetween. The jammable apparatus 600 is connected to the first portion 54 of the actuator 53 at a first end 13 of the jammable apparatus and is connected to the second portion 55 of the actuator at a corresponding second end 14.

A jammable apparatus may jam and exhibit an increase in its stiffness at a partially rearranged shape by the application of a first amount of relatively lower pressure within the envelope of the apparatus, and then be further rearrangeable and provided with increased jamming stiffness by an increase in the amount of relatively lower pressure within the envelope of the apparatus.

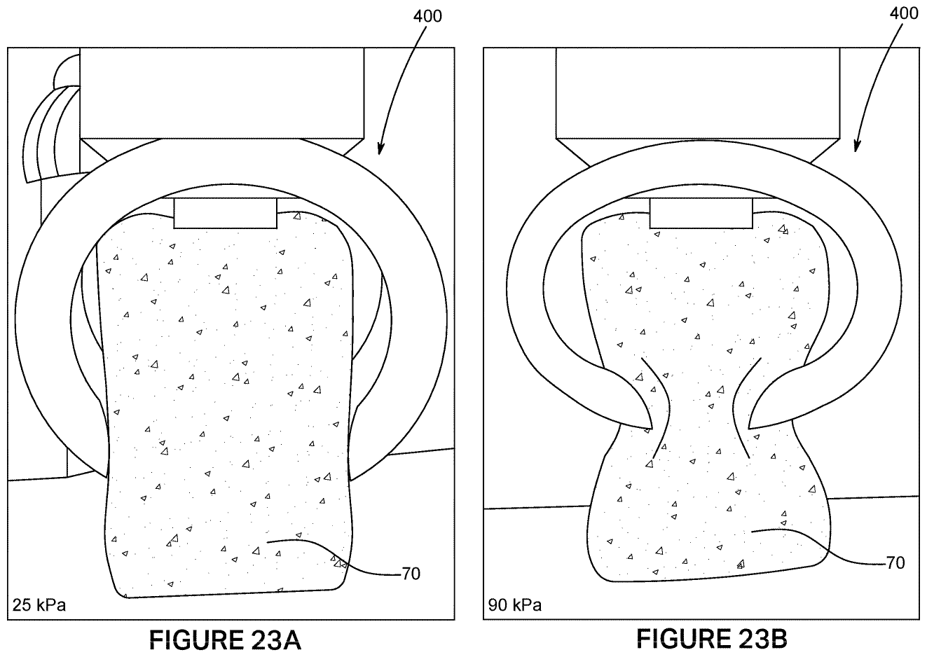

For example, FIGS. 23A and 23B show a jammable apparatus 400 utilised as a grasping actuator. In FIG. 23A the jammable apparatus 400 is shown lightly grasping a compressible sponge 70. As shown in FIG. 23A the jammable apparatus is partially jammed and partially articulated so that it is grasping the sponge 70. In the configuration of FIG. 23A a vacuum pressure of 25 kPa has been provided within the envelope. FIG. 23B shows the jammable apparatus of FIG. 23B, but where the vacuum pressure within the envelope has been increased to 90 kPa. The increased vacuum pressure causes the jammable apparatus 400 to further articulate towards the second apparatus shape and increases the stiffness of the jammable apparatus 400. As seen in FIG. 23B, the jammable apparatus 400 has compressed the sponge 70 adjacent to the respective ends of the jammable apparatus 400.

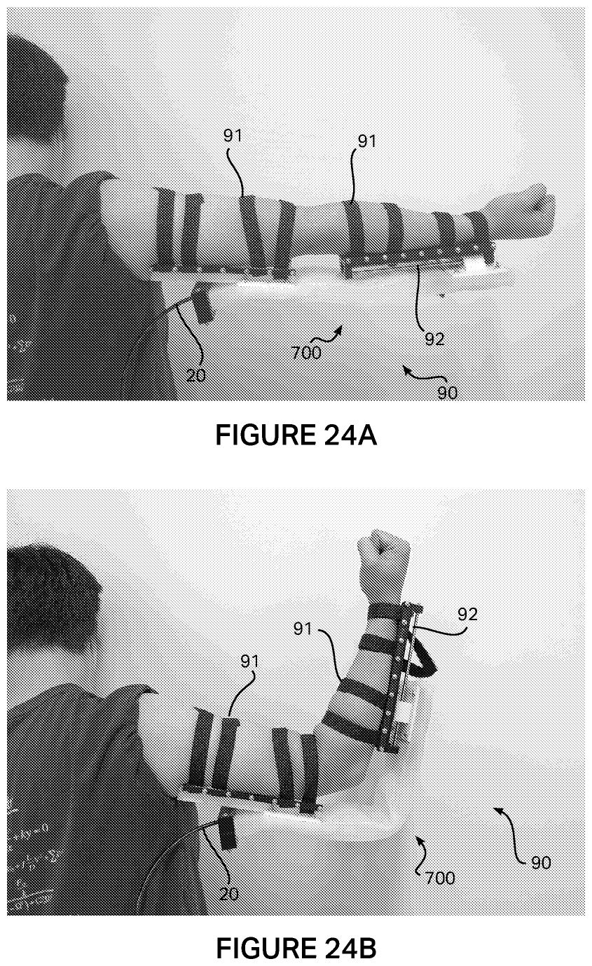

FIGS. 24A and 24B show a jammable apparatus 700 utilised as the actuator of a human arm exoskeleton 90. The exoskeleton 90 may be desired to be able to actuate to flex a person's arm. Accordingly, the jammable apparatus 700 may have a curved shape upon the exertion of the constricting force, and a straight shape in the absence of the constricting force.

The exoskeleton 90 includes attachments 91 for attaching the exoskeleton to a user's arm and may include one or more sliding rails 92 to accommodate movement of the ends of the jammable apparatus 700 relative to the user's arm as the jammable apparatus changes shape.

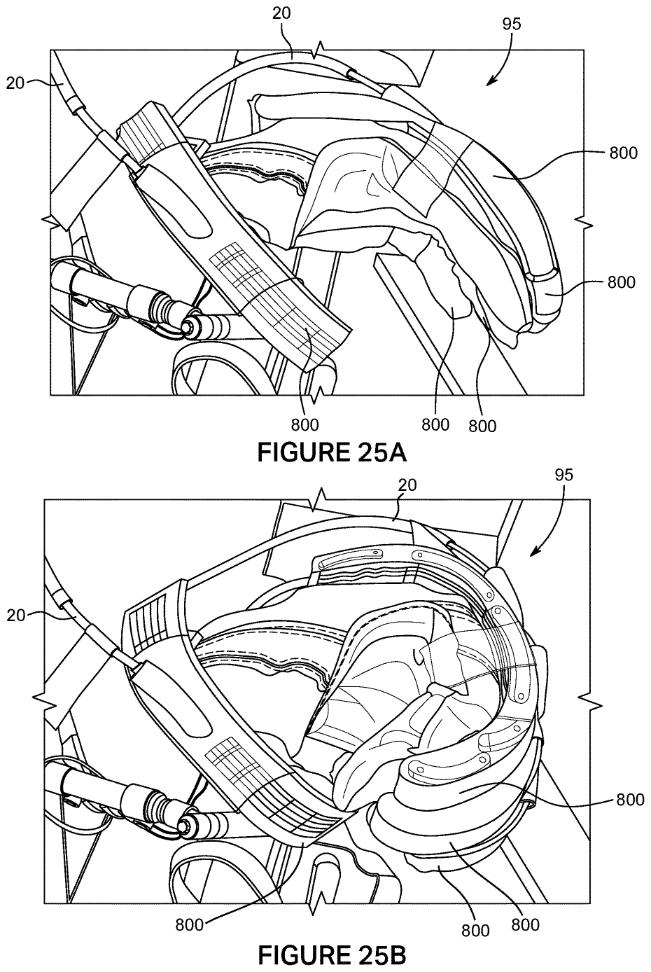

FIG. 24A shows the exoskeleton 90 attached to a person's arm with their arm in an extended condition. In this condition the jammable apparatus 700 may be in the first apparatus shape and unjammed. FIG. 25B shows the exoskeleton 90 when the jammable apparatus 700 has been actuated to the second apparatus shape by the exertion of a constricting force. When the constricting force is activated the jammable apparatus 700 becomes jammed, the resulting increased stiffness of the exoskeleton may increase the user's load capacity in flexion of their arm and/or the time for which they are able to maintain a given load in flexion.

The exoskeleton 90 of FIGS. 24A and 24B has been described which is operable to aid in flexion of a user's arm. However, by providing a jammable apparatus which has a first apparatus shape when the user's arm is flexed and a second apparatus shape when the user's arm is relatively more extended, an exoskeleton may be provided which can assist the operation of a user's arm in flexion.

Furthermore, by the use of two jammable apparatuses in an exoskeleton where the jammable apparatuses have opposite arrangements of their first and second apparatus shapes, an exoskeleton may be provided which is able to selectively either aid a user's arm in flexion or extension.

While illustrated in FIGS. 24A-B in relation to an exoskeleton for an arm, exoskeletons for supporting other parts of a user's body may be provided by application of the foregoing principles.

FIGS. 25A and 25B show a robotic hand 95 which incorporates a separate jammable apparatus 800 for each finger of the robotic hand. The jammable apparatuses 800 are each configured to have a relatively extended shape at rest, and to articulate towards a relatively more flexed shape upon the exertion of a constricting force on them. FIG. 25A shows the robotic hand 95 with each of the fingers in a relatively extended shape, for example the first apparatus shape being the shape when the constricting force is not exerted. FIG. 25B shows the robotic hand 95 with each of the fingers in a relatively more flexed shape, such as may be provided upon the exertion of the constricting force at each of the jammable apparatuses 800. As the jammable apparatuses 800 each jam under the influence of the constricting force, an articulation of each of the fingers of the hand are provided and the stiffness of the fingers in their flexed shape is increased.

While FIG. 25B illustrates the application of a constricting force to each of the jammable apparatuses 800 to provide a flexion of each of the fingers of the hand to form a closed fist, the constricting force may be provided separately to each of the fingers in order to selectively actuate one or more fingers and to independently control the stiffness of each finger.

Where in the foregoing description reference has been made to elements or integers having known equivalents, then such equivalents are included as if they were individually set forth.

Although embodiments have been described with reference to a number of illustrative embodiments thereof, it will be understood by those skilled in the art that various changes in form and details may be made therein without departing from the spirit and scope of the invention as defined by the appended claims. Therefore, the preferred embodiments should be considered in a descriptive sense only and not for purposes of limitation, and also the technical scope of the invention is not limited to the embodiments described. Furthermore, the present invention is defined not by the detailed description of the invention but by the appended claims, and all differences within the scope will be construed as being comprised in the present disclosure.

Many modifications will be apparent to those skilled in the art without departing from the scope of the present disclosure and illustrated in the accompanying drawings.

1-25. (canceled)

26. An apparatus comprising:
a conformable envelope configured to exert a constricting force corresponding to a difference between an internal pressure and a greater external pressure of the envelope;
an assembly comprising a plurality of rotatably associated rotation members arranged in the envelope and configured to rotatably move away from a first assembly position and toward a second assembly position in response to the constricting force; and
a first intermediate component arranged between the envelope and the assembly and configured to facilitate movement of the assembly between the first assembly position and the second assembly position.

27. The apparatus of claim 26, wherein the first intermediate component is configured to resiliently exert a returning force to cause the assembly to move away from the second assembly position and toward the first assembly position in response to the constricting force being smaller than the returning force.

28. The apparatus of claim 27, wherein the returning force is exerted on one of the envelope and the assembly.

29. The apparatus of claim 28, wherein the first intermediate component is configured to resist local deformation.

30. The apparatus of claim 29, wherein the first intermediate component is configured to be slidably moveable relative to the envelope.

31. The apparatus of claim 27, wherein the first intermediate component has a sliding surface configured to facilitate slidable movement of the assembly thereon.

32. The apparatus of claim 27, further comprising:
a second intermediate component arranged between the envelope and the assembly, the assembly being arranged between the first and second intermediate components.

33. The apparatus of claim 27, wherein the assembly further comprises:
a plurality of elongated pivot members to which the rotation members are rotatably coupled.

34. The apparatus of claim 33, wherein each intermediate one of the rotation members are rotatably coupled to a respective neighbouring pair of the pivot members.

35. The apparatus of claim 34, wherein each intermediate one of the rotation members is arranged symmetrically with respect to the respective pair of the pivot members.

36. The apparatus of claim 33, wherein the rotation members coupled to an intermediate one and a previous one of the pivot members are interleaved with those coupled to the intermediate one and a next one of the pivot members.

37. The apparatus of claim 33, wherein each of the rotation members is rotatably coupled at a proximal end thereof to one of the pivot members.

38. The apparatus of claim 37, wherein, for each of the pivot members, each adjacent pair of the corresponding rotation members forms a respective angle in the second assembly position.

39. The apparatus of claim 38, wherein the rotation members of each of the pivot members are arranged symmetrically with respect to the rotation members of an adjacent one of the pivot members.

40. The apparatus of claim 33, wherein each rotation member is rotatably coupled to at least one of the pivot members, and is formed with a plurality of coupling holes greater in number than the corresponding at least one of the pivot members.

41. The apparatus of claim 27, wherein the assembly further comprises:
a flexible base layer which is arranged in the envelope and on which the rotation members are arranged.

42. The apparatus of claim 41, wherein the base layer is configured to resiliently exert a restoring force to facilitate movement of the assembly away from the second assembly position and toward the first assembly position in the absence of the constricting force greater than the restoring force.

43. The apparatus of claim 42, wherein each of the rotation members includes an attachment part fixed to the base layer and a first non-attachment part rotatably moveable about the respective attachment part with respect to the base layer.

44. The apparatus of claim 43, wherein, for each rotation member in a first group, the respective attachment part is arranged toward a first peripheral side of the base layer relative to the respective first non-attachment part.

45. The apparatus of claim 27, wherein the envelope is adapted to receive therein an inner fluid corresponding to the internal pressure, and is adapted to be arranged in an outer fluid corresponding to the external pressure and different from the inner fluid.
